(19) United States
(12) Patent Application Publication
(10) Pub. No.: US 2025/0096276 A1
(43) Pub. Date: Mar. 20, 2025

(54) CATHODE INTERFACE COATING LAYERS FOR SOLID STATE BATTERIES

(71) Applicant: President and Fellows of Harvard College, Cambridge, MA (US)

(72) Inventor: Xin Li, Belmont, MA (US)

(21) Appl. No.: 18/897,865

(22) Filed: Sep. 26, 2024

Related U.S. Application Data
(60) Provisional application No. 63/539,467, filed on Sep. 20, 2023.

(51) Int. Cl. H01M 4/62; H01M 4/02; H01M 4/36; H01M 10/0562; H01M 10/44; H01M 50/431

(52) U.S. Cl. CPC H01M 4/628; H01M 4/366; H01M 10/0562; H01M 10/44; H01M 50/431; H01M 2004/028

(57) ABSTRACT

The invention provides compounds that can be used as cathode interface coating layers in solid state batteries. The compounds disclosed herein provide enhanced dynamic stability.

### FIELD OF THE INVENTION

The invention is directed to the field of solid state rechargeable batteries.

### BACKGROUND OF THE INVENTION

Thermodynamically stable interface voltage windows of solid electrolytes are often narrower than the operational voltage range necessary in a commercial battery. When batteries with solid electrolytes are utilized outside of their stable interface voltage windows, interfacial decomposition reactions occur that reduce the operational lifetime of the batteries. Previous attempts to solve this problem have focused on finding and incorporating coating materials for the solid electrolytes that are thermodynamically stable within the desired operational voltage range. Such searches have produced few materials containing all of the desired characteristics for a commercial battery.

Thus, there is a need for improved solid state batteries incorporating solid electrolytes.

### SUMMARY OF THE INVENTION

The invention provides compounds that can be used as cathode interface coating layers in solid state batteries. The compounds disclosed herein provide enhanced dynamic stability.

In one aspect, the invention provides a compound selected from Table 1:

TABLE 1

| Compound | Chemical formula |
|---|---|
| 1 | Ba₁Li₁B₁O₃ |
| 2 | Ba₁Li₁B₉O₁₅ |
| 3 | Ba₁Na₁Li₃B₆O₁₂ |
| 4 | Ba₂Li₁O₆ |
| 5 | Ba₂Li₂Zr₄F₂₂ |
| 6 | Ba₂Na₂Li₆B₁₂O₂₄ |
| 7 | Ba₄Li₁Bi₃O₁₂ |
| 8 | Ba₄Li₁Nb₃O₁₂ |
| 9 | Ba₄Li₁Ta₃O₁₂ |
| 10 | Ba₄Li₄Al₄F₂₄ |
| 11 | Ba₄Li₈P₈O₂₈ |
| 12 | Ba₅Li₂W₃O₁₅ |
| 13 | Ba₆Li₄B₂₀H₁₂O₄₄ |
| 14 | K₁Li₁B₄O₇ |
| 15 | K₁Li₁C₁O₃ |
| 16 | K₁Li₁Nd₂Mo₄O₁₆ |
| 17 | K₁Li₁S₁O₄ |
| 18 | K₁Li₁Sm₂Mo₄O₁₆ |
| 19 | K₁Li₃Si₁₂Sn₂O₃₀ |
| 20 | K₁Li₃Zr₂Si₁₂O₃₀ |
| 21 | K₁Na₁Li₂S₂O₈ |
| 22 | K₁Na₂Li₃Fe₂Si₁₂O₃₀ |
| 23 | K₂Li₁SC₁F₆ |
| 24 | K₂Li₁V₁O₄ |
| 25 | K₂Li₂Si₄O₁₀ |
| 26 | K₂Li₆Ca₁₄Ti₄Si₂₄O₇₂F₄ |
| 27 | K₂Li₆Zr₄Si₂₄O₆₀ |
| 28 | K₄Li₁I₁O₆ |
| 29 | K₄Li₂Al₂F₁₂ |
| 30 | K₄Li₄Y₄F₂₀ |
| 31 | K₅Li₂Nd₁F₁₀ |
| 32 | K₅Li₂Pr₁F₁₀ |
| 33 | K₆Li₂Mg₈Si₂₄O₆₀ |
| 34 | K₈Li₁₂B₄P₁₆O₅₆ |
| 35 | K₈Li₄B₄P₈O₃₂ |
| 36 | K₈Li₈B₃₂O₅₆ |
| 37 | Li₁Al₁P₁H₁O₅ |
| 38 | Li₁Al₁Si₄O₁₀ |
| 39 | Li₁Al₂H₆Br₁O₆ |
| 40 | Li₁B₁H₄O₄ |
| 41 | Li₁B₅H₂O₉ |
| 42 | Li₁Bi₁O₃ |
| 43 | Li₁Ca₁P₁O₄ |
| 44 | Li₁Ca₉Mg₁P₇O₂₈ |
| 45 | Li₁Cd₁B₁O₃ |
| 46 | Li₁Cl₁O₄ |
| 47 | Li₁CO₁H₁S₁O₅ |
| 48 | Li₁Co₁Ni₁O₄ |
| 49 | Li₁Co₁O₂ |
| 50 | Li₁Co₂O₄ |
| 51 | Li₁Eu₆B₃O₁₄ |
| 52 | Li₁F₁ |
| 53 | Li₁Fe₁C₂O₆ |
| 54 | Li₁Fe₁Si₂O₆ |
| 55 | Li₁Gd₆B₃O₁₄ |
| 56 | Li₁H₂Cl₁O₅ |
| 57 | Li₁H₃O₂ |
| 58 | Li₁H₆Br₁O₇ |
| 59 | Li₁La₂Fe₁O₆ |
| 60 | Li₁La₂S₂O₈F₃ |
| 61 | Li₁La₂Sb₁O₆ |
| 62 | Li₁La₃Mn₁O₇ |
| 63 | Li₁Mg₁Al₁F₆ |
| 64 | Li₁Mg₁Al₁Mo₃O₁₂ |
| 65 | Li₁Mg₄Al₁Mo₆O₂₄ |
| 66 | Li₁Mn₁H₁S₁O₅ |
| 67 | Li₁N₁O₃ |
| 68 | Li₁Nd₆B₃O₁₃F₂ |
| 69 | Li₁Ni₂O₃ |
| 70 | Li₁Ni₂O₄ |
| 71 | Li₁O₈ |
| 72 | Li₁PriS₂O₈ |
| 73 | Li₁Sc₁Si₂O₆ |
| 74 | Li₁Si₁B₁O₄ |
| 75 | Li₁Si₂B₁O₆ |
| 76 | Li₁Ta₁Si₁O₅ |
| 77 | Li₁Ta₃O₈ |
| 78 | Li₁Ti₁P₁O₅ |
| 79 | Li₁Ti₄Mn₁P₆O₂₄ |
| 80 | Li₁Tm₁Si₁O₄ |
| 81 | Li₁Y₁Si₁O₄ |
| 82 | Li₁Y₃Si₂O₈F₂ |
| 83 | Li₁Yb₁Al₁F₆ |
| 84 | Li₁Zr₂P₃O₁₂ |
| 85 | Li₁₀B₁₄Cl₂O₂₅ |
| 86 | Li₁₀Co₁Ni₉O₂₀ |
| 87 | Li₁₀Fe₃Ni₇O₂₀ |
| 88 | Li₁₀Mg₁₂Fe₁P₁₂O₄₈ |
| 89 | Li₁₀Sc₉Fe₁Si₂₀O₆₀ |
| 90 | Li₁₂Al₄Si₄O₂₀ |
| 91 | Li₁₂B₂₀H₈O₄₀ |
| 92 | Li₁₂Mn₁₁Fe₁P₁₂O₄₈ |
| 93 | Li₁₂P₁₂O₃₆ |
| 94 | Li₁₂Sc₈P₁₂O₄₈ |
| 95 | Li₁₂Ta₄O₁₆ |
| 96 | Li₁₃Mg₁Ni₁₂O₂₆ |
| 97 | Li₁₃Ni₁₅O₂₈ |
| 98 | Li₁₄Nb₁₄O₄₂ |
| 99 | Li₁₆Mn₁₅Fe₁P₁₆O₆₄ |
| 100 | Li₁₆Mn₈P₁₆O₅₆ |
| 101 | Li₁₆P₈O₂₈ |
| 102 | Li₁₆Zr₄F₃₂ |
| 103 | Li₁₈Al₆F₃₆ |
| 104 | Li₁₉Ni₂₃O₄₂ |
| 105 | Li₂Al₂P₂H₂O₁₀ |
| 106 | Li₂Al₂Si₈O₂₀ |
| 107 | Li₂Al₄H₁₂Br₂O₁₂ |
| 108 | Li₂Al₄H₁₂Cl₂O₁₂ |
| 109 | Li₂C₁O₃ |
| 110 | Li₂Ca₁₈Mn₂P₁₄O₅₆ |
| 111 | Li₂Ca₂Al₂F₁₂ |
| 112 | Li₂Cd₁Si₁O₄ |
| 113 | Li₂Cl₂ |
| 114 | Li₂Co₁Ni₃O₈ |
| 115 | Li₂Co₁O₂F₁ |
| 116 | Li₂Co₃Ni₁O₈ |
| 117 | Li₂Dy₂P₈O₂₄ |
| 118 | Li₂Fe₁Co₃O₈ |
| 119 | Li₂Fe₁O₂F₁ |
| 120 | Li₂Fe₃Bi₁O₈ |
| 121 | Li₂Fe₃Sb₁O₈ |
| 122 | Li₂Gd₂P₈O₂₄ |
| 123 | Li₂Ho₂P₈O₂₄ |
| 124 | Li₂La₁N₅O₁₅ |
| 125 | Li₂La₂P₈O₂₄ |
| 126 | Li₂Mg₁B₁₂H₁₆O₂₈ |
| 127 | Li₂Mg₁Ti₉O₂₀ |
| 128 | Li₂Mg₂S₃O₁₂ |
| 129 | Li₂Mn₁O₃ |
| 130 | Li₂Mn₁S₂O₈ |
| 131 | Li₂Mn₁₂P₁₄O₄₈ |
| 132 | Li₂Mn₄P₆O₂₀ |
| 133 | Li₂Nd₁N₅O₁₅ |
| 134 | Li₂Nd₂P₈O₂₄ |
| 135 | Li₂Ni₁O₃ |
| 136 | Li₂Pr₁N₅O₁₅ |
| 137 | Li₂S₁O₄ |
| 138 | Li₂Sc₁Fe₁Si₄O₁₂ |
| 139 | Li₂Sc₂P₄O₁₄ |
| 140 | Li₂Sc₂Si₄O₁₂ |
| 141 | Li₂Se₁O₄ |
| 142 | Li₂Si₁O₃ |
| 143 | Li₂Sm₂P₈O₂₄ |
| 144 | Li₂Sn₁H₁₀O₈ |
| 145 | Li₂Tb₂P₈O₂₄ |
| 146 | Li₂Ti₁O₃ |
| 147 | Li₂Ti₄P₆O₂₄ |
| 148 | Li₂Y₂F₈ |
| 149 | Li₂Y₂P₈O₂₄ |
| 150 | Li₂Y₆Si₄O₁₆F₄ |
| 151 | Li₂Yb₂Al₂F₁₂ |
| 152 | Li₂Zn₁Si₁O₄ |
| 153 | Li₂Zr₁F₆ |
| 154 | Li₃Al₁Si₁O₅ |
| 155 | Li₃B₃F₁₂ |
| 156 | Li₃Gd₁N₆O₁₈ |
| 157 | Li₃La₂H₆N₉O₃₀ |
| 158 | Li₃La₃Mo₂O₁₂ |
| 159 | Li₃Mg₃Al₃F₁₈ |
| 160 | Li₃Nb₁O₄ |
| 161 | Li₃Nd₃W₂O₁₂ |
| 162 | Li₃P₁O₄ |
| 163 | Li₃Sb₁O₄ |
| 164 | Li₃Ta₁O₄ |
| 165 | Li₃Tb₁N₆O₁₈ |
| 166 | Li₃V₁O₄ |
| 167 | Li₃Yb₁N₆O₁₈ |
| 168 | Li₄Al₂₀O₃₂ |
| 169 | Li₄Al₄P₁₆O₄₈ |
| 170 | Li₄B₁₂O₁₈F₄ |
| 171 | Li₄Ca₃₆Mg₄P₂₈O₁₁₂ |
| 172 | Li₄Co₁Ni₃O₈ |
| 173 | Li₄H₈Br₄O₄ |
| 174 | Li₄Mg₁₂P₁₂O₄₄ |
| 175 | Li₄Mg₄P₄O₁₆ |
| 176 | Li₄Mn₄P₁₂O₃₆ |
| 177 | Li₄Mn₄P₄O₁₆ |
| 178 | Li₄Mo₁O₅ |
| 179 | Li₄P₄H₈O₁₆ |
| 180 | Li₄SC₁Fe₃Si₈O₂₄ |
| 181 | Li₄Sc₂P₄H₂O₁₆ |
| 182 | Li₄Sc₄Si₄O₁₆ |
| 183 | Li₄Se₁O₅ |
| 184 | Li₄Si₂O₆ |
| 185 | Li₄Si₄O₁₀ |
| 186 | Li₄Ta₄Si₄O₂₀ |
| 187 | Li₄Ti₂F₁₂ |
| 188 | Li₄Ti₂Si₂O₁₀ |
| 189 | Li₄Ti₄P₄O₂₀ |
| 190 | Li₄Tm₄Si₄O₁₆ |
| 191 | Li₄W₁O₅ |
| 192 | Li₄Y₄Si₄O₁₆ |
| 193 | Li₄Zr₈P₁₂O₄₈ |
| 194 | Li₅I₁O₆ |
| 195 | Li₅Sc₂Fe₃Si₁₀O₃₀ |
| 196 | Li₆Al₆Si₆O₂₄ |
| 197 | Li₆B₁₄O₂₄ |
| 198 | Li₆Ca₆P₆O₂₄ |
| 199 | Li₆P₂O₈ |
| 200 | Li₆Sc₁Fe₅Si₁₂O₃₆ |
| 201 | Li₆Si₃F₁₈ |
| 202 | Li₆Ta₆O₉F₁₈ |
| 203 | Li₆Zr₈F₃₈ |
| 204 | Li₆Co₅O₁₂ |
| 205 | Li₇Ni₅O₁₂ |
| 206 | Li₈Al₆Si₆Cl₂O₂₄ |
| 207 | Li₈B₁₂O₁₆F₁₂ |
| 208 | Li₈B₁₆O₂₈ |
| 209 | Li₈B₈H₃₂O₃₂ |
| 210 | Li₈Ca₄B₃₂H₂₈O₇₀ |
| 211 | Li₈P₁₀H₂O₃₀ |
| 212 | Li₈Sc₁Fe₇Si₁₆O₄₈ |
| 213 | Li₈Sc₅Fe₃Si₁₆O₄₈ |
| 214 | Li₈Si₁₂O₂₈ |
| 215 | Li₈Si₁₆B₈O₄₈ |
| 216 | Li₈Ti₈P₁₂O₄₈ |
| 217 | Li₉Er₃Cl₁₈ |
| 218 | Li₉Ni₁₀O₂₀ |
| 219 | Na₁Li₁B₄O₇ |
| 220 | Na₁Li₁C₁O₃ |
| 22- | Na₁Li₁Fe₂Si₄O₁₂ |
| 222 | Na₁Li₁S₁O₄ |
| 223 | Na₁Li₁Si₁B₃H₁O₈ |
| 224 | Na₁Li₁Tm₂F₈ |
| 225 | Na₁Li₁Zr₁Si₆O₁₅ |
| 226 | Na₁Li₂P₁O₄ |
| 227 | Na₁Li₃Fe₄Si₈O₂₄ |
| 228 | Na₁Li₇Fe₈Si₁₆O₄₈ |
| 229 | Na₁Li₉Fe₁₀Si₂₀O₆₀ |
| 230 | Na₁₂Li₁₂Al₈F₄₈ |
| 231 | Na₁₂Li₁₂Sc₈F₄₈ |
| 232 | Na₁₆Li₈Al₈P₁₆H₁₆O₇₂ |
| 233 | Na₂Li₁Al₁F₆ |
| 234 | Na₂Li₂Er₄F₁₆ |
| 235 | NazLi₂Ho₄F₁₆ |
| 236 | Na₂Li₂Tm₄F₁₆ |
| 237 | Na₂Li₂Y₄F₁₆ |
| 238 | Na₂Li₄B₂P₄O₁₆ |
| 239 | Na₃Li₁Fe₄Si₈O₂₄ |
| 240 | Na₃Li₁Mg₄Si₁₂O₃₀ |
| 241 | Na₃Li₁W₁O₅ |
| 242 | Na₃Li₂Fe₄Si₁₀O₃₀ |
| 243 | Na₄Li₄B₁₆O₂₈ |
| 244 | Na₄Li₄Mg₄P₄O₁₆F₄ |
| 245 | Na₄Li₄Si₄B₁₂H₄O₃₂ |
| 246 | Na₄Li₄Zr₄Si₂₄O₆₀ |
| 247 | Na₄Li₈P₄O₁₆ |
| 248 | Na₅Li₁Fe₆Si₁₂O₃₆ |
| 249 | Na₅Li₁P₂O₈ |
| 250 | Na₆Li₂Mg₈Si₂₄O₆₀ |
| 251 | Na₈Li₄Y₄Si₂₄O₆₀ |
| 25 | Na₉Li₁Fe₁₀Si₂₀O₆₀ |
| 253 | Sr₁Li₁B₉O₁₅ |
| 254 | Sr₂Li₂Al₂F₁₂ |
| 255 | Sr₈Li₂B₂₂H₂O₄₃ |
| 256 | Sr₈Li₄B₂₄O₄₆ |

An aspect of the invention provides a solid state battery including an anode and a cathode including cathode particles and solid state electrolyte particles, a solid state electrolyte separating the anode and cathode, and an interface coating layer between the cathode particles and solid state electrolyte. The interface coating layer includes a compound of Table 1.

In another aspect, the invention provides a method of storing energy including applying a voltage across the anode and cathode and stably cycling any rechargeable battery disclosed herein. In another aspect, the invention provides a method of providing energy including connecting a load to the anode and cathode and discharging any rechargeable battery disclosed herein.

### BRIEF DESCRIPTION OF THE DRAWINGS

FIGS. 1(a)-1(f) show an illustration of dynamic voltage stability concept. FIG. 1(a) shows voltage stability window is opened by constriction with certain effective modulus (K_{eff}), where the effective stress ϵK_{eff} is composed of an actual local stress (σ_{local}) and a kinetic contribution (σ_{eff}^{kinetic}) caused by kinetic stability. FIG. 1(b) shows decomposition nuclei of electrolyte will compress the reaction front and freeze the ionic diffusivity (D) of the decomposition. FIG. 1(c) shows decomposition nuclei of electrode-electrolyte interface will compress the reaction front and freeze the ionic diffusivity (D) of the decomposition. FIG. 1(d) shows that due to compressive strain at the reaction front, the diffusivity of atoms drops dramatically, and the decomposition is kinetically stopped. FIG. 1(e) shows low porosity contacts of electrode and electrolyte at the micrometer scale. FIG. 1(f) shows solid-solid interface contact with many nanosized or sub-nanosized point contacts alternated by atomic scale gaps, giving inhomogeneous local chemical potential of lithium μ_{Li}(x) with strong x dependence and a development of reaction strain that cannot be easily released.

FIGS. 2(a)-2(d). FIG. 2(a) shows electrolyte dynamic voltage stability window, reaction strain and decomposition energy in response to constrictions by direct minimization method using LGPS as an example. The overall voltage stability window opens, and the reaction strain and decomposition energy decrease with increasing K_{eff}. FIG. 2(b) shows the less than 4 GPa effective pressure σ_{eff} induced by 0 to 5 V electrochemical decomposition under 0 to 20 GPa effective modulus K_{eff} for LGPS. FIG. 2(c) shows the metrics derived from the voltage window opening phenomenon: kₒₓ and kᵣₑ are the slope by which the upper and lower stability limits of Uₒₓ and Uᵣₑ increase and decrease with increasing K_{eff}. FIG. 2(d) shows the electrolyte distribution on the map of the window opening slope difference kₒₓ−kᵣₑ (kₒₓ>0 and kᵣₑ<0) versus intrinsic voltage stability window.

FIGS. 3(a)-3(b). FIG. 3(a) shows the negative correlation between the intrinsic window and the logarithmic Li ion conductivity^{[6-7, 27-39]}. FIG. 3(b) shows the electrolyte distribution on the map of the opening slope at oxidative voltage limit ko versus intrinsic voltage stability window.

FIG. 4 shows constriction induced voltage stability of Li solid-state electrolytes calculated by direct minimization method. Voltage window expansion at representative K_{eff} of sulfides (blue bars), oxides (green bars) and halides (purple bars). The red and blue lines in each bar denote the reduction and oxidation limit of the electrolyte. The numbers on the right of each bar, e.g., 7.3V@20 GPa denote the voltage window at (@) a given K_{eff}. The intensity of each color shows the magnitude of decomposition reaction strain.

FIGS. 5(a)-5(f) show high throughput search of coating materials for LGPS, LPSCl electrolytes and 4V—Li_{0.5}CoO₂ (LCO), 4V—Li_{0.5}Ni_{1/3}Mn_{1/3}Co_{1/3}O₂ (NMC111) and 4V—Li_{1/3}Ni_{7/9}Mn_{1/9}Co_{1/9}O₂ (NMC811). FIG. 5(a) shows the high-throughput screening procedure. FIGS. 5(b)-5(e) show electrochemical decomposition energy of the screened coating at SSE or cathode interfaces, and SSE/cathode interfaces as well, calculated by unconstrained ensemble (FIG. 5(b)) and constrained ensemble at K_{eff}=2 GPa (FIG. 5(c)), K_{eff}=20 GPa (FIG. 5(d)), and K_{eff}=23 GPa (FIG. 5(e)). FIG. 5(f) shows the critical effective modulus K* of each interface.

FIGS. 6(a)-6(b) show experimental examination of LiCoO₂|LiNbO₃ interface dynamic stability. FIG. 6(a) shows LiNbO₃ coated LiCoO₂ (LCO) shows a better cycling performance than bare LCO in solid state battery with mechanical constriction. FIG. 6(b) LiNbO₃ coated LCO shows a worse cycling performance than bare LCO in liquid battery without mechanical constriction.

FIGS. 7(a)-7(e) show critical effective modulus (K*) needed to stabilize the cathode/electrolyte electrochemical interface reaction at 4 V with different computational approaches. FIG. 7(a) shows the cathode and electrolyte are in direct contact. FIG. 7(b) shows a chemical interphase is formed first between the cathode and electrolyte, with which the electrolyte is in contact at 4V. FIG. 7(c) shows LCO-LGPS cathode composite solid-state battery cycling first at room temperature and then at 55° C. FIG. 7(d) shows the same battery cycled in the reversed temperature sequence. FIG. 7(e) shows temperature varying test for 811-LPSCl and 811-LGPS cathode composite cycled in solid-state batteries.

FIG. 8(a)-8(d) show high throughput search of coating materials for Li₇La₃Zr₂O₁₂ (LLZO) electrolytes and 4V—Li_{0.5}CoO₂ (LCO), 4V—Li_{0.5}N_{1/3}Mn_{1/3}Co_{1/3}O₂ (NMC111) cathodes. FIG. 8(a) shows the high-throughput screening procedure. Electrochemical decomposition energy of the screened coating/SSE or cathode interfaces, and SSE/cathode interfaces calculated by unconstrained ensemble (FIG. 8(b)) and constrained ensemble at K_{eff}=7 GPa (FIG. 8(c)), and the critical effective modulus K* of each interface at 4 V (FIG. 8(d)).

FIG. 9(a)-9(d) show high throughput search of coating materials for halide electrolytes and 4V—Li_{0.5}CoO₂, 4V—Li_{0.5}Ni_{1/3}Mn_{1/3}Co_{1/3}O₂ (NMC111) cathodes. FIG. 9(a) shows the high-throughput screening procedure. Electrochemical decomposition energy of the screened coating/SSE or cathode interfaces, and SSE/cathode interfaces calculated by unconstrained ensemble (FIG. 9(b)) and constrained ensemble at K_{eff}=7 GPa (FIG. 9(c)). FIG. 9(d) shows the critical effective modulus K of each interface.

FIG. 10 shows voltage stability window in response to mechanical constriction for different electrolytes.

FIGS. 11(a)-11(c). FIG. 11(a) shows comparison of hull energies at 4 V versus Li of {Li_{5.5}PS_{4.5}Cl_{1.5}—LiAlO₂}interface with unconstructed Li_{5.5}PS_{4.5}Cl_{1.5} and constricted Li_{5.5}PS_{4.5}Cl_{1.5} at K_{eff}=20 GPa (Li_{5.5}PS_{4.5}Cl_{1.5}@20 GPa). The dashed line corresponds to the sum of intrinsic instability of Li_{5.5}PS_{4.5}Cl_{1.5} and LiAlO₂ at 4V. FIG. 11(b) shows illustration of the change of hull after applying 35 GPa mechanical constriction at the interface of {Li_{5.5}PS_{4.5}Cl_{1.5}@20 GPa-LiAlO₂} at 4 V, and the comparison between K_{crit}(x)Vₓεₓ and K_{eff}Vₓεₓ. FIG. 11(c) shows K_{eff}Vₓεₓ of {Li_{5.5}PS_{4.5}Cl_{1.5}@20 GPa-LiAlO₂} interface at 4V at K_{eff}=35 GPa, and the definition of K*.

FIG. 12 shows halide electrolyte/oxide cathode coating after including LiₓCl_{y} as possible decomposition products.

FIG. 13 shows constriction induced voltage stability of the decomposition reaction of solid-state electrolyte (SSE). ΔG_{EC-RXN} is the Gibbs free energy of the electrochemical decomposition reaction. Uᵣₑ (K_{eff}), Uₒₓ(K_{eff}) and U_{w} (K_{eff}) are the reduction limit, oxidation limit and the voltage stability window of the electrolyte, respectively, which are all functions of the effective modulus K_{eff} in the unit of GPa representing the local level of mechanical constriction. ε is the reaction strain of a specific decomposition. (a) Perturbation method with just one oxidative decomposition reaction (red dots) and one reductive decomposition reaction (blue dots) at each voltage. The upward arrows show that the electrochemical decomposition energy is increased by mechanical constriction and the magnitude is proportional to reaction strain; (b) Direct minimization method demonstrated by an example of Li₁₀GeP₂S₁₂ (LGPS): all decomposition reactions are considered and the 4 voltage window determining reactions in the illustration are labeled with 4 different colors. The 4 thin solid lines show the electrochemical reaction Gibbs free energy change with respect to voltage without mechanical constriction, and the 4 solid thick lines show that of the reactions with effective modulus K_{eff} of 10 GPa.

### DETAILED DESCRIPTION OF THE INVENTION

The invention provides a solid state battery with an interface coating layer between cathode particles and solid electrolyte particles in the cathode that, under applied voltage, evolves from unstable to stable, providing a dynamic voltage stability for advanced battery performance. A constrained ensemble computational approach systematically evaluated and compared dynamic stability voltage windows in response to the mechanical constriction effect. High-throughput calculations screened coating materials for different interfaces between sulfide, halide, and oxide electrolytes and typical cathode materials with enhanced dynamic voltage stability. A demonstration with an assembled battery containing cathode particles with an interface coating layer to solid state electrolyte in the cathode layer shows the value of these computations to confirm the validity of predicted compounds described.

Solid state batteries are one of the most promising next-generate energy storage technologies, due to the potential to apply lithium metal anode for high energy density and much improved safety by preventing lithium dendrite penetration.^{[1-4]} For battery applications, the Li ion conductivity, voltage stability window, and mechanical properties are three key electrolyte parameters. Mechanical properties of solid electrolytes are of particular interest in solid state batteries. Low modulus of sulfides enables better contacts between the particles in the electrolyte and cathode mixture by a simple cold-press calendaring procedure.^{[5-7]} More importantly, these three parameters are often strongly coupled in a solid-state battery to greatly influence electrochemical behaviors.

In theory, the strictest definition of voltage stability window refers to the voltage range that the electrolyte can work without any electrochemical decompositions thermodynamically. Precise calculations of such intrinsic voltage windows of various types of solid electrolytes have been performed previously.^{[8-12]} However, in practice those intrinsic voltage windows are often narrower than the operational voltage range needed by a full battery, thus various decomposition reactions can still happen. This is especially true for sulfide solid electrolytes, where the intrinsic voltage window is only around 1.7˜2.3 V. Even considering the delithiation capacity in sulfide electrolyte, the effect can only widen the electrolyte voltage window to 2.5˜3 V.^{[13-14]}

In stark contrast, sulfide electrolyte-based solid state batteries can cycle well in experiment in a wide voltage range with Li metal anode and 4V cathodes, up to high current densities around 50 mA/cm², and in a wide operational pressure range from several hundred MPa down to a few MPa^{[2, 4, 15-20]}. These experimental facts suggest that certain stabilization mechanism must play a critical role here to widen the practical operational voltage window of solid-state batteries beyond the intrinsic voltage stability predicted by the standard convex hull computational approach.

It was found that for all-solid electrolyte batteries, although small decomposition could happen beyond the intrinsic voltage window, they often show self-limiting decomposition, meaning that the decomposition can stop quickly at a certain stage, giving the wide operational voltage stability in practice. This is in drastic difference to the case when the solid electrolyte is immersed in a liquid electrolyte, where the electrolyte decomposes deeply^{[5]}. This is because in the former case any volume expansion decomposition reaction has to overcome the mechanical constriction imposed at the solid-solid interface by the all-solid environment, which is a critical factor lacks in the latter case with liquid being added.

The local effective mechanical constriction modulus, K_{eff}, on the order of the bulk modulus of electrolytes has been proposed to strongly correlate with operational electrochemical stability through interactions with such positive reaction strains,^{[4-5, 15, 21-23]} where the reaction strain has been observed experimentally together with advanced battery performance. Solid-solid interface under mechanical constriction was shown to be able to penalize decomposition reaction nuclei with an energy scale on the order of K_{eff}εV, where E is the local reaction strain and V is a reference volume. That is, the effect can lead to a dynamic evolution from interface instability to stability, giving the so-called dynamic voltage stability for advanced performance of solid-state batteries with greatly widened operational voltage window of sulfide electrolytes in contact with 4 V cathode and 0 V Li metal anode.^{[5, 16, 24]}

In this work, we first articulate our state-of-the-art perspective on the thermodynamic and kinetic constitution of the dynamic voltage stability. We broaden the meaning of K_{eff} to include the kinetic stability, which allows the K_{eff}εV energy penalty to effectively stabilize interface reactions when the local stress is smaller than the fracture limit. This is a critical development of our constrained ensemble description for interface reactions in solid-state batteries, since most solid electrolyte materials do not have a high fracture toughness^{[25]}, but many of them can exhibit operational interface voltage stability way beyond the predicted limit of their thermodynamic voltage stability. We then further investigate the dynamic voltage stability for all the main types of Li solid electrolytes, including chalcogenides, oxides, halides and borohydrides, as well as their interface stability with coating materials for classic oxide cathodes. Here we apply our constrained ensemble computations across these solid-state electrolytes (SSEs) to systematically evaluate and compare their dynamic stability voltage windows in response to the mechanical constriction effect. High-throughput calculations based on pseudo-binary approach are used to search for coating materials for different interfaces between electrolyte and cathode materials with enhanced dynamic stability.

A comparison with experiment is given based on a readily available coating procedure for LiNbO₃ to demonstrate the unique prediction capability of our computational approach to design dynamic voltage stabilities by interface coatings. The detailed agreement between computation and experiment further highlights the potential value of the ˜150 new cathode interface coating materials predicted in this work. Our work thus will speed up the solid-state battery development by providing a promising list of candidate coating materials to the field with a potential to significantly stabilize the cathode interface reactions during the battery cycling.

### Batteries

Batteries of the invention include an anode, a cathode including cathode particles and solid state electrolyte particles, a solid state electrolyte, and an interface coating layer between the cathode particles and the solid state electrolyte particles in the cathode layer. The interface coating layer can include any compound from Table 1.

### Interface Coatings

The interface coating between the cathode particles and solid state electrolyte particles includes a compound of Table 1. Interface coating layers may also include additional materials, such as polymers from the coating procedure as described herein. Upon battery cycling, the interface coating layer will react with either cathode or solid state electrolyte, or both, so that chemical elements from both cathode and solid state electrolyte may be mixed into the interface coating layer through interface reactions or forming new phases. These interface reactions, however, will be self-limited to stop quickly, so that the thickness of interphase reaction layer is well limited. The as-formed interphase layer will provide both electrochemical voltage stability in the following cycles and sufficient Li ion conductivity due to the limited thickness.

The thickness of the interface coating layer surrounding the cathode particles or solid electrolyte particles can be 0.1 nm to 1 μm, e.g., about 1-100 nm (e.g., about 1-10 nm, 1-25 nm, 10-20 nm, 20-30 nm, 25-50 nm, 30-40 nm, 40-50 nm, 50-60 nm, 50-75 nm, 60-70 nm, 70-80 nm, 75-100 nm, 80-90 nm, or 90-100 nm, e.g., about 1 nm, 5 nm, 10 nm, 20 nm, 30 nm, 40 nm, 50 nm, 60 nm, 70 nm, 80 nm, 90 nm, or 100 nm), e.g., about 100-1000 nm (e.g., about 100-110 nm, 100-125 nm, 100-200 nm, 200-300 nm, 250-500 nm, 300-400 nm, 400-500 nm, 500-600 nm, 500-750 nm, 600-700 nm, 700-800 nm, 750-1000 nm, 800-900 nm, or 900-1000 nm, e.g., about 100 nm, 200 nm, 300 nm, 400 nm, 500 nm, 600 nm, 700 nm, 800 nm, 900 nm, or 1000 nm).

### Anodes

Anodes of the invention may be any suitable anode known in the art, such as Li metal. For example, lithium metal foil, e.g., Li metal foil on a current collector, e.g., of stainless steel. The lithium metal can also mix or alloy with Na, Mg, Al, Si, K, Ca, Sc, Ti, V, Cr, Mn, Fe, Co, Ni, Zn, Ga, Ge, As, Rb, Sr, Y, Zr, Nb, Mo, Ag, Cd, In, Sn, Sb, Bi, Cs, Te, or a combination thereof to form one single layer.

Anodes may be deposited on an appropriate substrate, e.g., a fluoropolymer or carbon. For example, liquefied polytetrafluoroethylene (PTFE) has been used as the binder when making solutions of electrode materials for deposition onto a substrate. Other binders are known in the art. The anode materials described herein can be used without any additives. Alternatively, the anode material may have additives to enhance its physical and/or ion conducting properties. For example, the anode materials may have an additive that modifies the surface area exposed to the solid electrolyte, such as carbon. Other additives are known in the art.

### Cathodes

Cathode materials can be chosen to have optimum properties for ion transport. For example, the cathode may preferably be LiNi_{0.8}Mn_{0.1}Co_{0.1}O₂ (NMC811) due to its high capacity, energy density, and also cost effectiveness due to the decreased composition of the expensive Co element. Other materials for use as electrodes in solid state electrolyte batteries are known in the art.

The cathodes may be a solid piece of the material, or alternatively, may be deposited on an appropriate substrate, e.g., a fluoropolymer or carbon. For example, liquefied polytetrafluoroethylene (PTFE) has been used as the binder when making solutions of cathode materials for deposition onto a substrate. Other binders are known in the art. The cathode material can be used without any additives. Alternatively, the electrode material may have additives to enhance its physical and/or ion conducting properties. For example, the cathode materials may have an additive that modifies the surface area exposed to the solid electrolyte, such as carbon. Other additives are known in the art.

In some embodiments, the cathode can include, e.g., LiNi_{0.8}Mn_{0.1}Co_{0.1}O₂ (NMC811), LiNi_{0.33}Mn_{0.33}Co_{0.33}O₂ (NMC111), LiNi_{0.5}Mn_{0.3}Co_{0.2}O₂ (NMC532), LiNi_{0.6}Mn_{0.2}Co_{0.2}O₂ (NMC622), LiNi_{0.9}Mn_{0.05}Co_{0.05}O₂ (NMC955), LiNiₓMn_{y}Co_{(1-x-y)}O₂ (0≤x,y≤1), LiNiₓCo_{y}Al_{(1-x-y)}O₂ (0≤x,y≤1), LiMn₂O₄, LiMnO₂, LiNiO₂, Li_{1-z}NiₓMn_{y}Co_{(1-x-y-z)}O₂ (0≤x,y,z≤1), Li_{1+z}NiₓMn_{y}Co*Al_{(1-x-y-z-s)}O₂ (0≤x,y,z,s≤1), Li_{1-z}NiₓMn_{y}CoₛW_{(1-x-y-z-s)}O₂ (0≤x,y,z,w≤1), V₂O₅, selenium, sulfur, selenium-sulfur compound, LiCoO₂ (LCO), LiFePO₄, LiNi_{0.5}Mn_{1.5}O₄, Li₂CoPO₄F, LiNiPO₄, Li₂Ni(PO₄)F, LiMnF₄, LiFeF₄, or LiCo_{0.5}Mn_{1.5}O₄. The cathode can be coated with LiNbO₃, LiTaO₃Li₂ZrO₃, LiNb_{X}Ta_{1-X}O₃ (0≤x≤1), yLi₂ZrO₃-(1-y)LiNb_{X}Ta₁₋ₓO₃ (0≤x, y≤1), Al₂O₃, TiO₂, ZrO₂, AlF₃, MgF₂, SiO₂, ZnS, ZnO, Li₄SiO₄ Li₃PO₄. Li₃InCl₆, Li₁₊ₓAlₓTi₂₋ₓ (PO₄)₃(0<x<2), LiMn₂O₄, LiInO₂—LiI, Li₆PS₅Cl, LiAlO₂, a polymer, or carbon. In some embodiments, the cathode includes a polymer and/or carbon black, or the first and/or second solid electrolytes include a polymer.

The cathode can be mixed with polymer and/or carbon. Examples of polymers may include polyethylene oxide, polyvinylidene fluoride, poly(vinylidene fluoride-co-hexafluoropropylene), poly(ethyl methacrylate), or poly(vinylidene fluoride-co-trifluoroethylene). The particle size of cathode materials can be 1 nm-30 μm.

The loading of the cathode can be 0.1-100 mg/cm². The thickness of the cathode can be 5 μm-2000 μm. The cathode may be mixed with solid state electrolyte materials to provide increased cathode capacity.

Other cathode materials such as selenium or sulfur that exhibit promising high capacity and energy density also show much better cycling performance in our multilayer design than the single layer design.

In certain embodiments, the cathode can be mixed with polymer and carbon black, solid electrolytes can be mixed with polymer. Examples of polymers may include polyethylene oxide, polyvinylidene fluoride, poly(vinylidene fluoride-co-hexafluoropropylene), poly(ethyl methacrylate), or poly(vinylidene fluoride-co-trifluoroethylene). The thickness of the solid electrolyte layer is 5-1000 μm. The thickness of the cathode can be 5-2000 μm.

### Solid State Electrolytes

Suitable solid state electrolytes that may be used in the invention include inorganic solid electrolytes, e.g., crystalline or glassy inorganic lattices with high ionic conductivity, in which ions (e.g., Li⁺ ions) can diffuse through the lattice. SSEs may be, for example, oxides, halide, chalcogenides, borohydrides, phosphates, or sulfides of lithium (e.g., LGPS, LiSiPS, LiPS, Li_{5.5}PS_{4.5}Cl_{1.5} (LSPCl_{1.5}), Li₆PS₅Cl_{1.0} (LPSCl_{1.0}).

Other solid state electrolyte materials that may be suitable include sulfide solid electrolytes, e.g., SiₓP_{y}S_{z}, e.g., SiP₂S₁₂, or β/γ-PS₄. Other solid state electrolytes include, but are not limited to, germanium solid electrolytes, e.g., GeₐP_{b}S_{c}, e.g., GeP₂S₁₂, tin solid electrolytes, e.g., Sn_{d}PₑS_{f}, e.g., SnP₂S₁₂, iodine solid electrolytes, e.g., P₂Sal crystals, glass electrolytes, e.g., alkali metal-sulfide-P₂S₅ electrolytes or alkali metal-sulfide-P₂S₅— alkali metal-halide electrolytes, or glass-ceramic electrolytes, e.g., alkali metal-P_{g}Sₕ₋ᵢ electrolytes. Other solid state electrolyte materials are known in the art. The solid state electrolyte material may be in various forms, such as a powder, particle, clay, or solid sheet. An exemplary form is a powder.

Solid electrolytes may be deposited or cast on an appropriate substrate, e.g., a Polyester (PET) film, a cathode, an anode, or other layers of solid electrolytes. For example, Nitrile rubber (NBR), Acrylate rubber (ABR), Polyisobutene (PIB) have been used as the binder when making solutions of electrolyte materials for deposition onto a substrate. Other binders are known in the art. Solid electrolytes may be mixed with solvents (e.g., p-xylene, isobutyl isobutyrate or a mixture thereof, e.g., anhydrous p-xylene and isobutyl isobutyrate (1:1 vol/vol)) and binders (e.g., a polymer, e.g., an arylate polymer, e.g., from 0.5% to 5 wt %) to prepare a slurry for layer formation. Multiple layers of electrolytes can be deposited or cast or transferred to a substrate layer-by-layer. The multilayer may contain ‘n’ layers of solid state electrolytes (where n=e.g., 1, 2, 3, 4, 5, 6, 7, 8, 9, 10, etc.).

Advantageously, the solid state electrolyte may adopt a core-shell particle structure, e.g., core-shell LPSCl-X (where X is a halide) or LGPS (Li₁₀GeP₂S₁₂) (see, WO 2019/104181, WO 2020/112843, and WO2022/094412). LGPS (Li₁₀GeP₂S₁₂) may also adopt a core-shell particle structure. The shell can include a compound of Table 1. Solid state electrolyte particles, e.g., core-shell particles, may have a cross sectional dimension, e.g., diameter, of between about 1 nm and about 30 μm, e.g., about 1-100 nm (e.g., about 10 nm, 20 nm, 30 nm, 40 nm, 50 nm, 60 nm, 70 nm, 80 nm, 90 nm, or 100 nm), e.g., about 100-1000 nm (e.g., about 100 nm, 200 nm, 300 nm, 400 nm, 500 nm, 600 nm, 700 nm, 800 nm, 900 nm, or 1000 nm), e.g., about 1-10 μm (e.g., about 1 μm, 2 μm, 3 μm, 4 μm, 5 μm, 6 μm, 7 μm, 8 μm, 9 μm, or 10 μm), or, e.g., about 10-30 μm (e.g., about 10 μm, 12 μm, 13 μm, 14 μm, 15 μm, 16 μm, 17 μm, 18 μm, 19 μm, 20 μm, 21 μm, 22 μm, 23 μm, 24 μm, 25 μm, 26 μm, 27 μm, 28 μm, 29 μm, or 30 μm). In core-shell particles, the shell may make up from about 0.1% to about 99.9% of the particle, e.g., about 1-10%, about 10-20%, about 20-30%, about 25-50%, about 40-60%, about 50-75%, about 60-80%, about 75-90%, or about 80-99% of the particle, by, e.g., volume or mass. Stability may be determined experimentally.

### Mechanical Constriction

In some embodiments, the battery interface is under local mechanical constriction. Mechanical constriction at the interface between the solid state electrolyte and the cathode can limit the extent of chemical or electrochemical decomposition of solid state electrolyte materials by volumetric constraint. Local stress on the order of a few GPa up to the fracture limit of solid electrolyte, may be generated from mechanical constriction. Local compressive strain at reaction front can indue a diffusion limiting process to limit interface reaction, contributing a kinetic part to the local effective constriction modulus beyond the fracture limit. One condition to implement the mechanical constriction can be an external pressure applied to the battery cell of at least 0.1 MPa up to several hundred MPa. The level of external pressure for a battery is determined by the battery material, material processing, and battery assembly methods. Mechanical constriction may be provided by a formation pressure from cold and/or hot and/or warm isotropic and/or anisotropic press and/or rolling with the external pressure on the order of 0.1 MPa to 1000 MPa and temperature at 25° C.-500° C. Examples of suitable assembly methods include, but are not limited to, warm isotropic pressing (WIP), cold isotropic pressing (CIP), and hydraulic cold pressing of the battery cell or pouch. The mechanical constriction may result from an applied pressure of at least 0.05 MPa, e.g., at least 0.1 MPa, 0.5 MPa, 1 MPa, 5 MPa, 10 MPa, 15 MPa or 20 MPa, e.g., about 0.05 MPa to about 50 MPa, e.g., about 0.05 MPa to about 0.1 MPa, about 0.075 MPa to about 0.15 MPa, about 0.1 MPa to about 1 MPa, about 0.1 MPa to about 10 MPa, about 1 MPa to about 30 MPa, about 20 MPa to about 40 MPa, about 30 MPa to about 50 MPa, about 40 MPa to about 60 MPa, about 50 MPa to about 70 MPa, about 60 MPa to about 80 MPa, about 70 MPa to about 90 MPa, or about 80 MPa to about 100 MPa, about 100 MPa to about 200 MPa, about 200 MPa to about 400 MPa, about 300 MPa to about 500 MPa, about 400 MPa to about 600 MPa, about 500 MPa to about 700 MPa, about 600 MPa to about 800 MPa, about 700 MPa to about 900 MPa, or about 800 MPa to about 1,000 MPa, e.g., about 70 MPa, about 75 MPa, about 80 MPa, about 85 MPa, about 90 MPa, about 95 MPa, about 100 MPa, about 150 MPa, about 200 MPa, about 250 MPa, about 300 MPa, about 350 MPa, about 400 MPa, about 450 MPa, about 500 MPa, about 550 MPa, about 600 MPa, about 650 MPa, about 700 MPa, about 750 MPa, about 800 MPa about 850 MPa, about 900 MPa, about 950 MPa, or about 1,000 MPa. Greater mechanical constriction may be applied during battery fabrication. After providing the formation pressure, the porosity of the cathode, and/or multilayer may be 0%-50%. In some embodiments, the mechanical constriction is sufficient to raise the local effective modulus above K_{eff}, thereby preventing decomposition, or such that a local stress field caused by decomposition of the solid state electrolyte raises K_{eff} above K_{crit}, thereby arresting decomposition.

When the battery is operating, the local stress can be maintained by applying an operational stack pressure on the order of between 0 MPa and 1000 MPa. Alternatively, the local stress may be maintained without applying an operational stack pressure.

Methods Methods of storing and releasing electrical energy involve using electrical energy to charge a solid state battery by applying a voltage across the battery that causes Li to migrate as Li⁺ ions from a cathode to an anode, where the Li deposited, thereby storing the electrical energy as chemical energy. In discharge, the Li metal is oxidized to Li⁺ and migrates back to the cathode.

To release (discharge) the stored chemical energy as electrical energy, a load is electrically connected between the anode and cathode in a circuit to allow the Li⁺ ions to migrate from the anode via the solid state electrolyte to the cathode.

Methods of the invention may involve repeating the above cycle multiple times, e.g., greater than 1000 times, e.g., 1000-20,000 times (e.g., 1,000-1,500 times, 1,250-1,750 times, 1,500-2,000 times, 1,500-2,500 times, 2,000-3,000 times, 2,500-5,000 times, 5,000-10,000 times, 5,000-15,000 times, 10,000-20,000 times, or 15,000-20,000 times).

The method may include first allowing a portion of the interface coating layer to form a surface layer on the cathode, e.g., in an initial charge-discharge cycle. Alternatively, the cathode may already have an interface coating layer. All suitable techniques can be used to apply the compounds of Table 1 to cathode particles, e.g., chemical synthesis, atomic layer deposition, chemical vapor decomposition, sputtering, pulsed laser decomposition, etc.

### Model

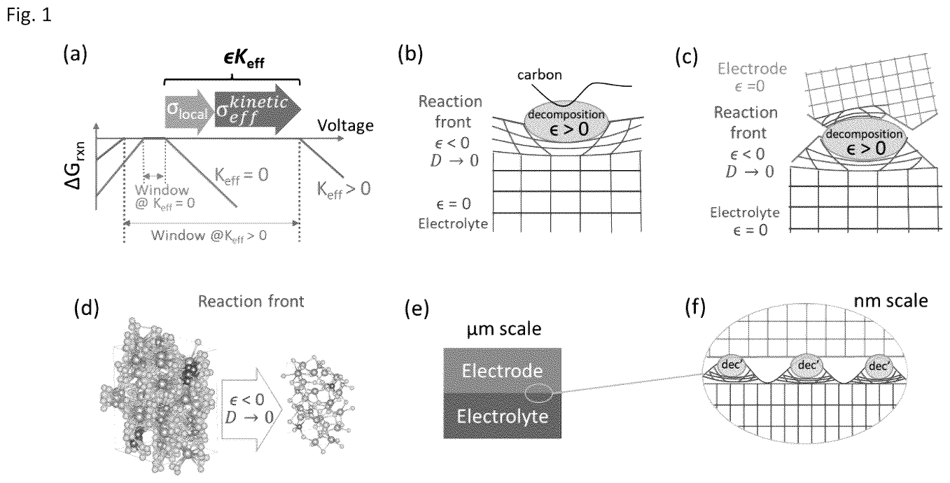

Here, we first explain the physical meaning of the dynamic voltage stability using our state-of-the-art understanding and formula description, which forms the foundation for further high-throughput search and design of interface coating materials with enhanced such stability. The local effective modulus K_{eff} and the effective stress σ_{eff}=εK_{eff} describe the level of local mechanical constriction. It is important to note that the effective stress can often be larger than the actual local stress σ_{local} (FIG. 1a), because σ_{eff}=σ_{local}+σ_{eff}^{kinetic}, where the latter term σ_{eff}^{kinetic} is an effective stress contributed by a kinetic diffusion-limiting process.

The plastic local strain field ε together with the actual local stress σ_{local} from the initial local decomposition provide the common strain energy Eₛₜᵣₐᵢₙ∝σ_{local}εV for thermodynamic metastability for any interface voltage reaction. More precisely, Eₛₜᵣₐᵢₙ=∫σ_{local} Vdε. However, the magnitude of the strain energy is limited by the plastic deformation and the fracture limit of electrolyte materials, beyond which there is no local mechanical constriction. Simultaneously, at the reaction front, the same local inhomogeneous strain field ε can significantly decrease the ionic interdiffusion in the electrolyte by orders of magnitude to kinetically prevent further decomposition propagation, giving an ionic passivation effect from local reaction strain induced diffusion limiting process. Interface reactions will thus feel the significant effect from an additional energy stabilization term from the kinetic stability, E_{kinetic}, for much wider interface voltage stability than what can be provided by thermodynamic metastability.

Since both energy terms of Eₛₜᵣₐᵢₙ and E_{kinetic} share the same local reaction strain term e, we have E_{kinetic}=∫σ_{eff}^{kinetic}Vdε, which defines the kinetic part of the effective stress σ_{eff}^{kinetic}. The total stabilization energy that includes both thermodynamic metastability and kinetic stability for interface reactions is thus Eₜₒₜₐₗ=Eₛₜᵣₐᵢₙ+E_{kinetic}=∫(σ_{local}+σ_{eff}^{kinetic}) Vdε, which defines the total effective stress σ_{eff}=σ_{local}+σ_{eff}^{kinetic}. Since σ_{eff}=εK_{eff}, we thus also have Eₜₒₜₐₗ=ϵK_{eff}V in the simplest format as the effective mechanical constriction energy.

More specifically, as illustrated in FIGS. 1b-c, the volume expansion decomposition with positive reaction strain (ϵ>0) compresses the surrounding electrolyte region, giving a local negative (compressive) strain (ϵ<0) at the reaction front of the undecomposed electrolyte. It was previously estimated that a 5% such local compressive strain will dramatically decrease the local ionic diffusivity D by orders of magnitude^{[22}], giving a zero local diffusivity (D→0) at the reaction front in practice to shut down further interface reaction, as any solid-state decomposition will need sufficient ionic interdiffusion to happen kinetically (FIGS. 1b,c,d).

This kinetic stability mainly requires a positive reaction strain at a local reaction interface under mechanical constriction (i.e., low porosity at micrometer scale as in FIG. 1e), which in principle can be satisfied by most electrolytes upon a proper solid state battery design. For sulfide or halide, for example, a cold press is often sufficient. However, even if it is well constricted with low porosity at micrometer scale, at (sub)-nanometer scale the solid-solid interface between electrolyte and electrode materials can still be inhomogeneous spatially with a strong x dependence. This accordingly gives an inhomogeneous local lithium chemical potential μ_{Li}(x) due to the dry interface contact with many nanosized or sub-nanosized point contacts that are alternated by atomic scale gaps (FIG. 1f). In contrast, when a lithium-ion concentration is homogeneously surrounding a particle immersed in the liquid electrolyte, the electrolyte and electrode form the classical surface contact rather than point contacts, giving a homogeneous local chemical potential of lithium.

Thus, in liquid electrolyte batteries, the reaction front can propagate deeply to consume the electrolyte^{[5]}, as the reaction strain field is flat with small curvature to be more easily released to the liquid environment, giving little effective stress to self-limit the decomposition. In contrast, in solid state batteries, reaction strain was found to build up plastically without a release. This is due to the inhomogeneous μ_{Li}(x), giving large local curvatures of the strain field (FIG. 1f), where the local positive and negative strain fields are coupled and locked at the reaction front to give the self-limiting decomposition by the effective stress σ_{eff}.

The effective stress σ_{eff}=ϵK_{eff} thus could be larger than both the actual local stress σ_{local} and the fracture limit σ_{frac} of the electrolyte materials without forming any actual fractures, as long as σ_{eff}>σ_{frac}>σ_{local} is satisfied. In practice it will need the initial local decomposition to be suppressed quickly so that σ_{local} is maintained at a low level, which is a property of interface reaction that can be designed. In addition, it also needs the electrolyte material to exhibit sufficient plastic deformation capability.

Therefore, in solid state batteries there could be an important dynamic evolution of electrochemical process, where the local compressive strain at the reaction front induced by the tensile strain from initial decomposition will kinetically shut down the ionic diffusion locally by encapsulating the local decomposition by the ionically passivated reaction front layer, preventing further decomposition and crack formation. To design such interface reactions, technically, for any electrolyte material or its interface with electrodes, there is a critical effective modulus, K_{crit}^{[26]} or K*^{[15]}, beyond which the local reaction can be fully suppressed. This critical modulus can be calculated by making K_{eff}ϵV equal the decomposition hull energy Eₕᵤₗₗ, thus a smaller K* or K_{crit} is preferred, as it suggests that the decomposition is easier to be suppressed by K_{eff}.

Importantly, we also point out here that since for a given decomposition hull energy Eₕᵤₗₗ, a larger local reaction strain ϵ will give smaller K* from Eₕᵤₗₗ=K*ϵV, and simultaneously, larger e also indicates stronger ionic passivation at the reaction front, looking for interfaces with smaller critical modulus K* thus also forms one important aspect to design the kinetic stability induced by the ionic passivation effect.

The above description forms our state-of-the-art understanding of the so-called dynamic voltage stability or simply dynamic stability that was proposed previously in an experimental work,^{[4]} where advanced battery performance was demonstrated by utilizing the effect. This interpretation of dynamic voltage stability also goes beyond our previous works^{[5, 15, 26]} by clearly stating that first, significant portion of the kinetic stability energy E_{kinetic} is already included in the term of K_{eff}ϵV; second, the inhomogeneous local lithium chemical potential μ_{Li}(x) at the solid-solid interface is critical to the formation of the plastic reaction strain; and third, the quantitative condition of σ_{eff}>σ_{frac}>σ_{local} needs to be satisfied to avoid fractures with sufficiently small local reaction stress, which however shares the same local reaction strain to simultaneously prevent further decomposition by sufficient effective stress. This interpretation forms an indispensable foundation for our computational approach to design dynamic stability presented in the following sections regarding intrinsic voltage stability window and interface coating materials that is of importance to the performance of solid state batteries.

### EXAMPLES

### A. Electrolyte Dynamic Voltage Stability Window in Response to Constrictions

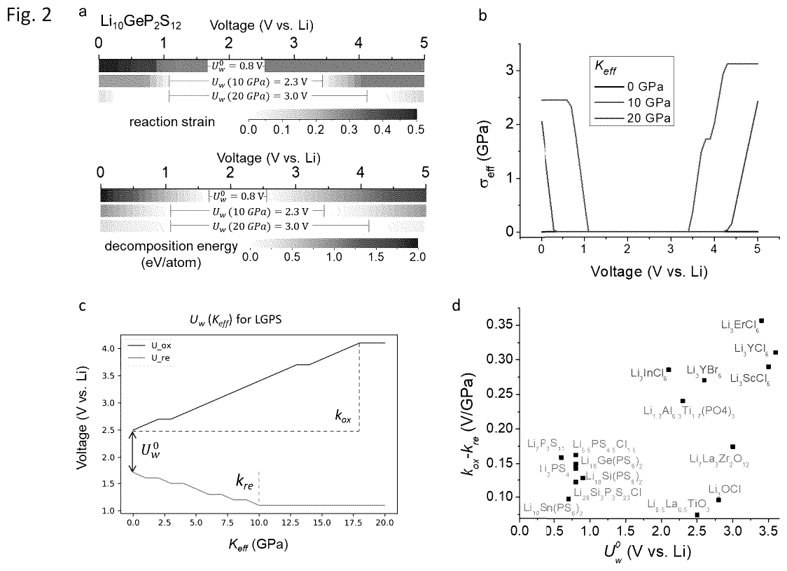

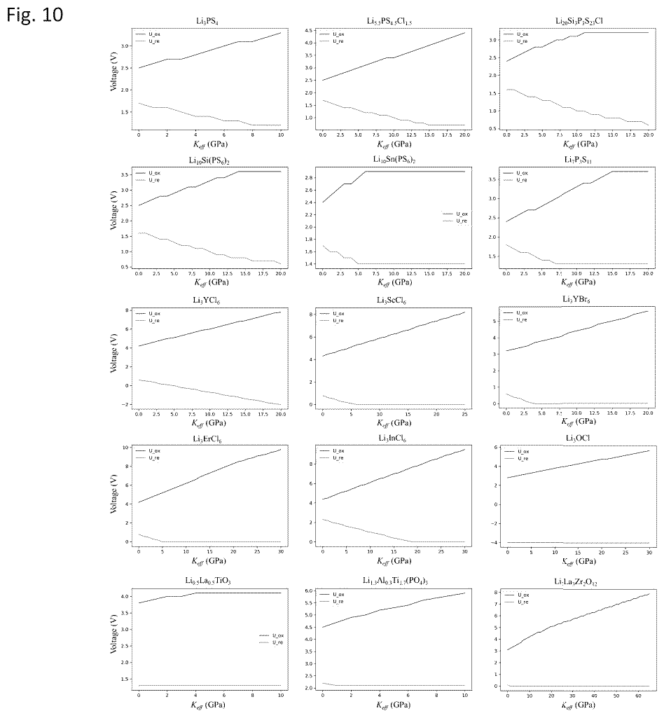

The dynamic voltage stability window of solid electrolytes is calculated by the minimization method (see Methods). We systematically calculated the voltage window and reaction strain in response to mechanical constriction for three mainstream types of electrolytes, including sulfides, halides and oxides (FIG. 10 for raw data). FIGS. 2(a)-2(c) use Li₁₀GeP₂S₁₂ (LGPS) as an example to illustrate the phenomenon. FIG. 2(a) shows the voltage stability window and the reaction strain at different voltages from 0 to 5 V and at different K_{eff} of 0, 10 and 20 GPa. With increasing K_{eff}, the voltage window can be opened, if the reaction strain is positive at the voltage beyond the voltage window. Table 2 shows more detail of decomposition energy, reaction strain, and decomposition product at 4V at different K_{eff}.

Outside the stability window at a given voltage, the thermodynamic decomposition energy decreases with increasing K_{eff}. With increasing K_{eff} the reaction strain also decreases and approaches zero eventually, giving the limit of voltage window opened by this thermodynamic metastable process. However, since the thermodynamic driving force for decomposition also decreases with increasing K_{eff}, it makes other nonequilibrium decomposition processes with larger reaction strains become more competitive and thus more likely to happen. Those nonequilibrium reactions thus may override the thermodynamic metastable evolution pathway, which is an effect that could give an even wider operational voltage window in a properly designed practical battery than what can be predicted by the minimization method here.

FIG. 2(b) shows the effective stress induced by electrochemical decomposition under different effective modulus K_{eff} calculated by multiplying the modulus with the reaction strain in the minimization method. We emphasize that the effective modulus and effective stress, although with the unit of GPa, are different from the actual local stress. The effective stress is less than 3 GPa at 0˜20 GPa K_{eff} due to the less than 30% reaction strain at low K_{eff} and the fact that with increasing K_{eff} the reaction strain decreases. Since σ_{eff}=σ_{local}+σ_{eff}^{kinetic} and the compliant yet brittle nature of sulfide^{[25]}, it can be estimated that the magnitude of σ_{local} is comparable to σ_{eff}^{kinetic}, and thus thermodynamic metastability and kinetic stability contribute comparably to the dynamic voltage stability of intrinsic voltage window.

FIG. 2© analyzes the change of the oxidation limit Uₒₓ and reduction limit Uᵣₑ of LGPS with changing K_{eff}. U_{w}⁰ is the intrinsic voltage window at zero constriction. Uₒₓ stops increasing at K_{eff}=18 GPa, while U, stops increasing at K_{eff}=10 GPa. We define kₒₓ and kᵣₑ as the two average slopes of Uₒₓ(K_{eff}) and Uᵣₑ(K_{eff}), where kₒₓ>0 and kᵣₑ<0. The slope difference kₒₓ−kᵣₑ reflects the net voltage window opening rate with respect to the application of mechanical constriction K_{eff}, which can be considered as a metric to measure the susceptibility of the voltage window opening effect for different materials in response to mechanical constriction.

As shown in FIG. 2(d), sulfides and oxides show similar levels of kₒₓ−kᵣₑ, while halides show higher kₒₓ−kᵣₑ due to the high absolute value of both kₒₓ and kᵣₑ (Table 5, FIG. 10). This suggests that halide electrolyte can show stronger voltage effect in response to mechanical constriction compared with sulfide electrolyte. For oxide electrolyte, at the reduction side kᵣₑ is almost zero, which suggests that oxide solid electrolyte may benefit less from the dynamic voltage stability against lithium dendrite penetration that was found in sulfide and halide. However, oxides show kₒₓ values between sulfides and halides, suggesting the constriction effect may still play a role at the cathode side for oxide electrolyte if the solid-solid interface between electrolyte and cathode particles can be well constricted, i.e., forming a good interface contact.

For U_{w}⁰, the values for sulfides are the lowest, while oxides and halides with stronger chemical bonding due to higher electronegativity of O²⁻, Cl⁻ and Br⁻ show much higher U_{w}⁰. Therefore, in the (kₒₓ−kᵣₑ) vs. U_{w}⁰ plot (FIG. 2(d)), sulfides, oxides, and halides occupy the bottom left region, middle-bottom right region, and top right region, respectively.

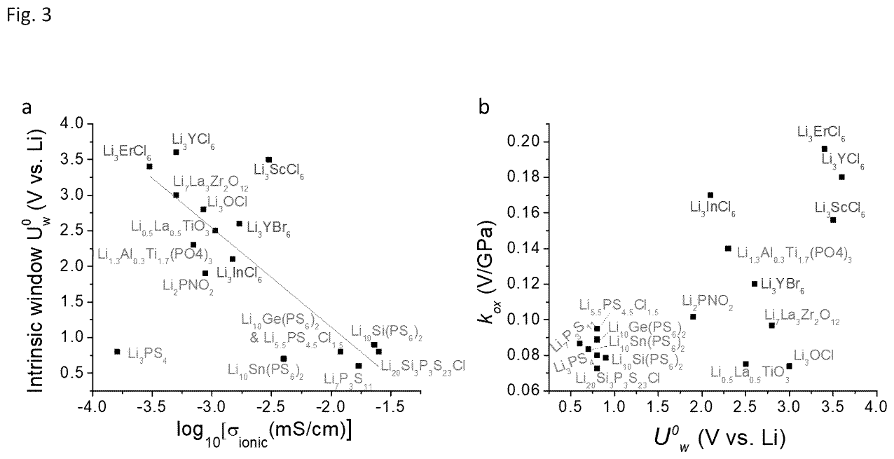

FIG. 3(a) shows an interesting negative correlation between intrinsic voltage window U_{w}⁰ and the logarithmic ionic conductivity. Sulfide occupies the bottom right corner, while oxides and halides occupy along the linear fitting line toward the top left region. A general picture for this relationship is that the fast lithium ion conduction in sulfide electrolyte is strongly contributed by certain soft phonon modes and their anharmonic couplingsl^{[40]}, which meanwhile also imply relatively weak bonding that reduces the intrinsic stability of the electrolyte, thus giving the narrower intrinsic voltage window for sulfides.^{[41]}

Since kᵣₑ is zero only for oxide, for a fair comparison with halide and sulfide, we plot kₒₓ vs. U_{w}⁰ in FIG. 3(b). The two correlations here (FIGS. 3(a)-(b)) suggest that electrolyte materials with high voltage opening susceptibility to mechanical constriction often tend to show low ionic conductivity together with hard phonon mode and chemical bonding. However, the fact that sulfide electrolytes can already show sufficient dynamic voltage stability suggests that when looking for new materials a kₒₓ or kᵣₑ value at the level of sulfide around 0.1 V/GPa is sufficient and higher such susceptibility value will likely come at an expense of reduced ionic conductivity.

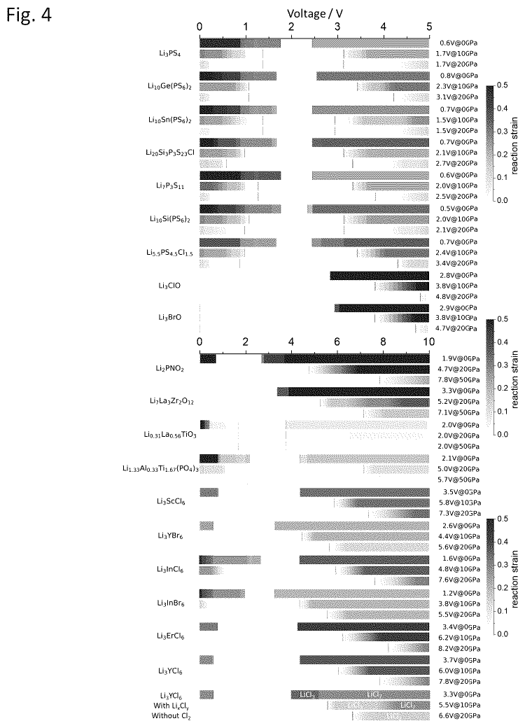

FIG. 4 shows the voltage stability and reaction strain at different K_{eff} three types of solid electrolytes. Previously an inclusion or nucleation decay model was used to describe the decomposition inside a constricted LGPS,^{[22]} which can be applied to the decomposition everywhere inside a theoretically dense pellet of polycrystalline SSE. According to the inclusion model, K_{eff}≈0.5 Kᵥ where K_{c} is the bulk modulus of the SSE, which gives K_{eff} about 15-20 GPa for sulfides, Li₃ClO and Li₃BrO, and above 50 GPa for other oxides. Intermediate constriction values of K_{eff}=10 GPa or 20 GPa are also considered for comparison. One obvious trend for all the electrolytes in FIG. 4 is that at each voltage, the reaction strain becomes smaller beyond the voltage window with increasing K_{eff}, which is due to the larger energy penalty for larger-strain reactions in the reaction space at higher constriction level. This also reveals that the smaller-strain reactions are the thermodynamically most preferred.

### A.1 Sulfides

The results of 7 representative sulfides are shown by the blue bars. Most of their oxidative limits can be opened from ˜2.5 V to larger than 3V. LGPS and Li_{5.5}PS_{4.5}Cl_{1.5} (LPSCl) can be opened to larger than 4V. The effect of mechanical constriction on glass sulfides, glass-ceramic sulfides, thio-LISICON, including Li₃PS₄, Li₇P₃S₁₁, LGPS, LSPS have been retrospectively reviewed^{[23]}, suggesting that constriction induced voltage stability should have been a key concept in sulfides since the first glassy-ceramic sulfides.

Noted that other than LGPS and Li_{5.5}PS_{4.5}Cl_{1.5}, the oxidative limits do not or barely further increase with the increase of K_{eff} from 10 GPa to 20 GPa. This is due to the existence of decomposition with negative reaction strains (defined to be 0 in calculation, as discussed in Methods) shown by the light-blue color above the oxidative limit, causing no thermodynamic stability in response to constriction. In these cases, dynamic voltage stability can be further adjusted by using the strategies of coating or more generally the interface composition modification, as we will discuss in part B. Briefly, the requirement of K_{eff} can be lowered for a given oxidative limit, as long as higher reaction strain can be designed to such an interface so that the decomposition can be more easily suppressed (i.e., reducing the critical effective modulus K*^{[15,26]}).

### A.2 Oxides

The result of six representative oxides is shown by the green bars in FIG. 4, including anti-perovskite type Li₃OCl and Li₃OBr, LIPON type Li₂PNO₂, garnet type Li₇La₃Zr₂O₁₂ (LLZO), perovskite type Li_{0.5}La_{0.5}TiO₃ (LLTO), and NASICON type Li_{1.3}Al_{0.33}Th_{1.67}(PO₄)₃ (LATP). Oxidative limits can be raised close to 5V or even higher than 7V, except for LLTO which decomposes to Li, LiO₈, TiO₂, Li₃TiO₃, La₂Ti₄O₉ and La₂Ti₂O₇ with negative reaction strain at 4.3 V at 10 GPa, limiting its oxidative limit at 4.3V. Note that at 0 K DFT computations, oxygen molecule crystal (13.5 Å³/atom) appears in the decomposition products of LLZO (11.6 Å³/atom), LLTO (12 Å³/atom) and LATP (12.3 Å³/atom), but the atomic volume of the oxygen is not too far from the electrolytes, so the reaction strain in our calculation here is not provided by the possible gas phase at room temperature (RT). For high modulus oxides such as LIPON, LLZO and LATP, to examine the effect of mechano-electrochemistry, it is important to get a dense electrolyte pellet with lowest possible porosity. Techniques such as pulsed laser deposition (PLD) or coating deformable materials under cold press at interface are thus needed for these oxides^{[42]}. In addition, whether these electrolytes can exhibit sufficient plastic deformation upon local decomposition is yet to be investigated, which may be another factor to limit the expansion of voltage window by K_{eff}.

Noted that Li₃OCl and Li₃OBr are with low enough modulus to be cold pressed into a dense pellet and have a 4.8 V oxidative limit at K_{eff}≈0.5 Kᵥ. Together with high Li conductivity on the order of 10⁻³-10⁻² mS/cm^{[39, 43-44]}, they are also very promising high voltage electrolytes. In computation, the decomposition products are Li, LiCl, LiClO₄ beyond oxidative limit at K_{eff} from 0 GPa to 20 GPa. Experimentally, trace amount Ba doped Li₃ClO has shown high RT Li conductivity of 25 mS/cm, and its oxidative limit is measured to be higher than 8 V even at 130° C.^{[43]}. The much wider 8 V stability than the 4.8 V stability in our computation could be due to the high kinetic barrier in forming the high valence Cl⁷⁺ in the decomposition product of LiClO₄. Other potential decomposition products in Li—Cl—O system could be non-solid ClₓO_{y} that become energetically competitive at RT than the OK products, which result in larger reaction strain and thus a dynamic voltage window beyond 4.8 V. Therefore the 8 V stability of Li₃ClO could be due to such kinetic stability beyond the constriction induced thermodynamic metastability at RT.

### A.3 Halides

Six halide electrolytes of Li₃MX₆ (M=Y, In, Er, Sc, X=Cl, Br) are considered. Their oxidative decomposition products are always Li, MX₃ and X₂ and the increase of reaction strain in a few tens of volts above the oxidative limit is due to the increasing portion of partial decomposition of Li₃MX₆ in the multi-phase equilibrium region of Li-M-X grand potential phase diagram. If there is any Cl₂ gas release in such a battery, the contribution from the volume of Cl₂ to reaction strain will disappear, causing negative reaction strain of ˜−15%, thus probably no broadening of voltage window above 4.3 V. As the data in Materials Project are calculated at 0 K, Cl₂ is crystalized molecules cluster. Removing Cl₂ from potential decomposition products in computation will give infinite oxidation limit since other compounds in the Li-M-X systems cannot compose a balanced reaction equation due to the lack of Cl-rich phases. Note that Cl-rich NaₓCl_{y} phases, i.e. NaCl₃ and NaCl₇ can form under GPa order of pressure^{[45]}, Cl-rich LiₓCl_{y} counterparts may also exist and can form under GPa level mechanical constriction. As there is no report on Cl₂ gas release experimentally, it is possible that halide electrolytes are either well constricted in batteries so that it is stable, or CI-rich LiₓCl_{y} phases are formed during decomposition. In such a case, the predicted voltage window is shown at the bottom of FIG. 4 with LiₓCl_{y} phases labeled in the corresponding voltage range where the related decomposition happens. Although the voltage window shrinks a little when unconstrained, it can still open to 6.6 V at 20 GPa level of local mechanical constriction. Similar scenarios may happen for Li-M-Br electrolytes as Br₂ is in the liquid state at room temperature.

### B Interface Dynamic Voltage Stability in Response to Constrictions

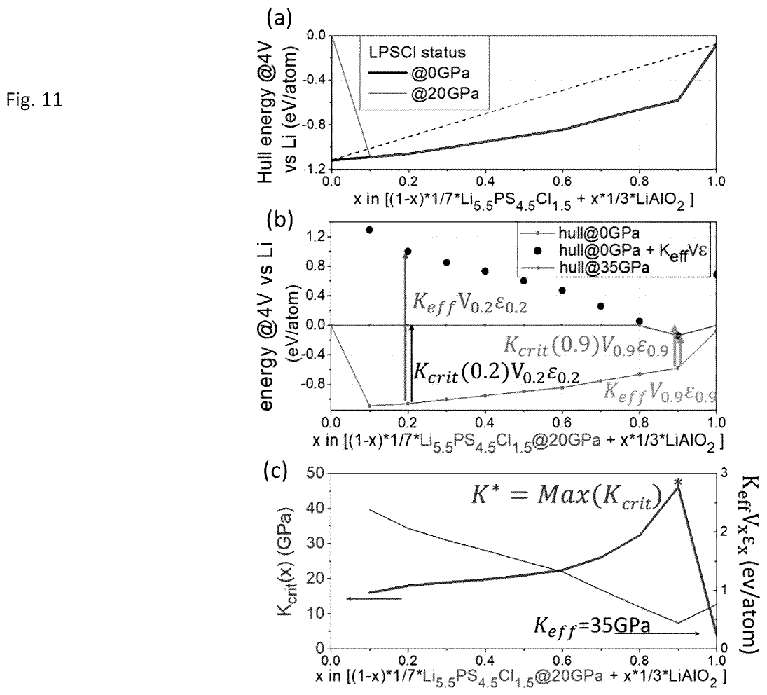

The interface electrochemical stability is calculated by pseudo-phase approach^{[12]} within the perturbation method framework (see Methods and FIG. 11). The constriction induced dynamic voltage stability model is compatible with high-throughput computational platform to search for promising interface coating materials that can provide enhanced interface dynamic stability.

### B.2 High-Throughput Search Under Constrained Ensemble for Li Sulfide Electrolyte Coating Materials

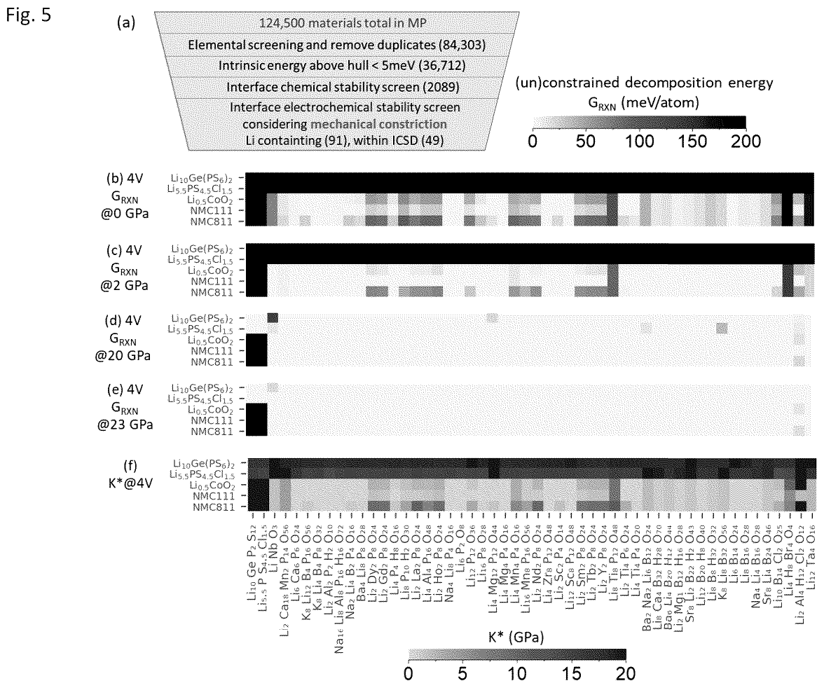

FIG. 5(a) shows the high-throughput screening procedure for searching potential coating materials for interfaces between cathode and sulfide electrolyte materials. We first screened out the materials with radiative elements and removed duplicates to reduce computational cost. The second screening criterion selected stable phase entries with hull energy <5 meV/atom. The third one considers the initial interface chemical stability of coating/pristine cathode and coating/electrolyte. Coatings whose interfacial decomposition energies are less than 50 meV/atom can pass the third screening step. There are 2089 materials that pass the third screening.

Lastly, we examine the electrochemical stability of the interfaces by unconstrained and constrained ensemble pseudo-binary interface simulations: If the interface electrochemical decomposition energy at 4 V is <50 meV/atom at K_{eff}=20 GPa, the material will become a coating candidate to help stabilize cathode interface reaction. We choose 20 GPa because it is a value roughly half of the bulk modulus of sulfide or halide electrolyte materials, which is around the maximum mechanical constriction that can be provided at the solid-solid interface based on the inclusion model^{[22]}. Our goal is thus to predict cathode coating materials that can bring the critical effective modulus K* below 20 GPa, where a lower K* below 10 GPa or 5 GPa is in general more preferred, as they make the interface reaction easier to be suppressed by local mechanical constriction K_{eff}.

There are 91 Li containing materials that passed all the screening steps. We selected 49 of them within ICSD id to present in FIGS. 5(a)-5(e). FIGS. 5(b) to 5(e) show the interface decomposition energies of 49 candidates plus LGPS, LPSCl and a commonly used coating LiNbO₃ for comparison, which is calculated by unconstrained ensemble (0 GPa in FIG. 5(b)), slightly constrained ensemble (2 GPa in FIG. 5(c)), and 20 GPa and 23 GPa constrained ensemble (FIGS. 5(d)-5€).

Without coating, the direct interface between cathode and electrolyte cannot be electrochemically stabilized even at 23 GPa due to small response to constriction as indicated by the large K* value in FIG. 5(f). Furthermore, all these coatings are highly electrochemically reactive with LGPS and LPSCl when unconstrained due to the electrochemical intrinsic instability of sulfide electrolytes and the interface reaction between coating and electrolyte. However, these coating interfaces are largely stabilized (<50 meV/atom) at 20 GPa or 23 GPa.

For the LiNbO₃ and cathode interfaces, the decomposition products are just Li, O₂ and Nb₂O₅, so the interface is in principle stable. However, LiNbO₃ itself is thermodynamically unstable at 4V at 0 GPa. Nevertheless, we find that the 4V decomposition can be stabilized by a modest 2 GPa constriction. Note that such a small constriction might also be provided by Nb diffusion^{[46-47]} induced surface tension at the cathode particle level in a liquid electrolyte battery, so that although unconstrained at the cell device level, Li—Nb—O coating can still improve the cycling performance of NCM811. Comparing LiNbO₃ with other predicted coatings in FIG. 5(d), LiNbO₃ shows the largest K* with LGPS, indicating that these predicted coatings could also be promising. For example, Li—Ta—O based coating (right most in the list) can show better rate performance than Li—Nb—O based coating.^{[48]} The predicted Li—B—O based coating has also been proven to improve LiCoO₂ performance, and can have better first cycle capacity than Li—Nb—O.^{[49-50]} But since experimentally LiNbO₃ coating can be easily implemented by a simple two-steps method of solution evaporation and calcination^{[46]}, coating a predicted material and achieving better cycling performance than that of LiNbO₃-coated one may require some nontrivial innovations in the synthesis procedure.

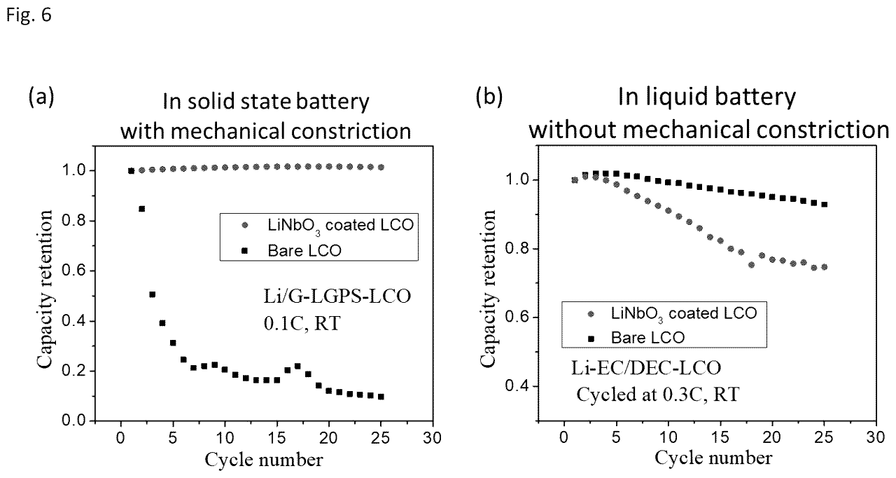

Here we use LiNbO₃|LiCoO₂ (LCO) interface as a model system to experimentally demonstrate the importance of dynamic voltage stability in predicting coating materials for solid state batteries. For solid state battery with LGPS as cathode electrolyte (FIG. 6(a)), bare LCO shows much worse cycling stability than LiNbO₃ coated LCO at room temperature, consistent with our prediction that the LCO and LGPS interface is unstable at any K_{eff} values while LiNbO₃ can help stabilize the interface when a nonzero K_{eff} is applied.

Since it is difficult to remove mechanical constriction in a solid-state battery to make K_{eff}=0, we tested liquid electrolyte batteries without mechanical constriction and thus K_{eff}=0 (FIG. 6(b)). In contrast, LiNbO₃ coated LCO now shows worse cycling stability than bare LCO, consistent with our prediction that LiNbO₃ and LCO interface is not stable when K_{eff} is zero. Note that the LCO case discussed here is different from LiNbO₃ coated NMC811 discussed earlier, where the coating does improve the cycling in liquid electrolyte batteries.^{[46]} This may suggest a lack of Nb diffusion induced surface tension in the coated LCO in comparison with coated NMC, as in the NMC case the surface tension can serve as a nonzero K_{eff} in the liquid electrolyte battery to help stabilize the interface between NMC and LiNbO₃.

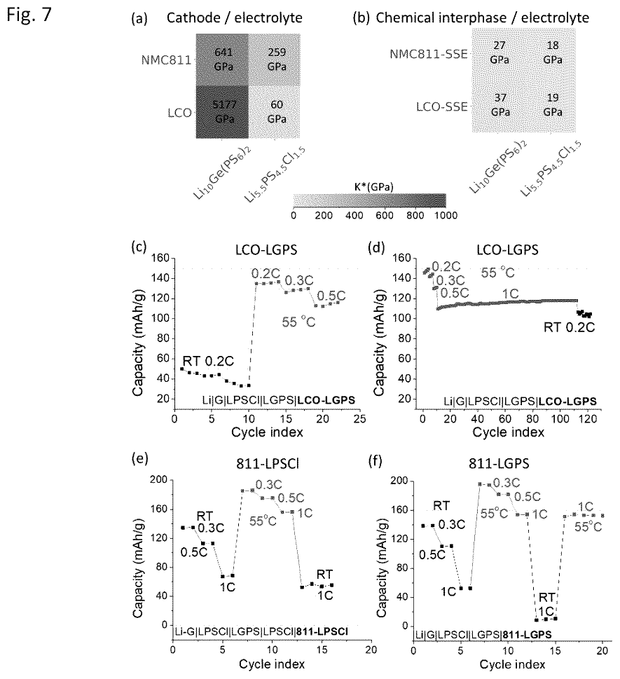

Although coating is a general strategy to improve the interface stability, we found that LCO and Li(Ni_{0.8}Mn_{0.1}Co_{0.1})O₂ (NMC811) can sometimes cycle with sulfide electrolytes even without cathode coating^{[4, 15-16]}. For such an interface, the initial chemical interphase formed by the direct contact between the cathode and electrolyte during powder mixing in mortar and cathode film formation in battery assembly before the application of voltage for electrochemical reaction should be considered.^{[26]} FIGS. 7(a)-7(b) show another computational approach by first considering such a preformed chemical interphase between the corresponding cathode and electrolyte from pseudo-phase calculation without applying a voltage (See Methods). We then calculate K* at the interface between the interphase and cathode at 4V (FIG. 7(b)), which greatly reduces K* by orders of magnitude than the interface between the solid electrolyte and cathode (FIG. 7(a)). This suggests that these new interphases, once preformed, can make the interface reactions much more easily stabilized at 4V.

We further tested uncoated LCO and NMC811 cathode with sulfide cathode electrolytes in solid-state batteries. For LCO-LGPS cathode composite, it can barely cycle directly at room temperature with less than 50 mAh/g capacity and a fast capacity decay, but surprisingly, we found that it can cycle at 55° C. (FIG. 7(c)). More importantly, after more than 100 stable cycles at 55° C., it then can be cycled at room temperature (FIG. 7(d)). We then test the NMC811-sulfide cathode composite with varying temperatures (FIGS. 7(e)-7(f)), which shows that NMC811-sulfide can already be cycled directly at room temperature, and high temperature does not improve its subsequent room temperature performance. These results suggest that LCO-sulfide chemical interphase, which serves to stop further decomposition by dynamic voltage stability and improve interface contacts, requires a higher temperature to form than that of NMC811-sulfide.

### B.2 High-Throughput Search Under Constrained Ensemble for Li Oxide Electrolyte (LLZO) Coating Materials

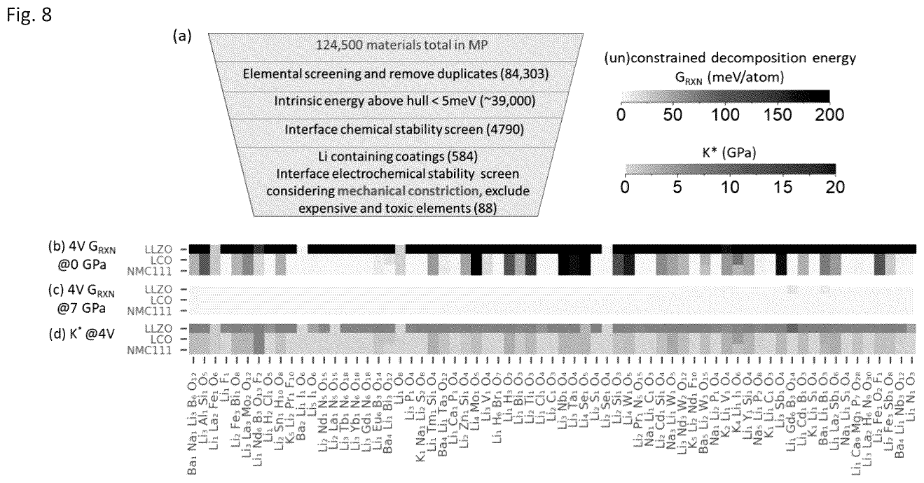

A classic garnet type LLZO is used as an example of oxide electrolyte to explore the interface reaction by constrained ensemble (FIGS. 8(a)-8(d)). Note that we added an elemental screening to remove the expensive (>50 USD/lb) and toxic elements to narrow down the final list. The challenge for the garnet electrolyte-cathode interface lies in the good contact and low interfacial resistance within low thermal processing window.^{[51]} Binding electrolyte and cathode together with a electrochemically stable coating material is a useful strategy.^{[52-54]} When unconstrained, since LLZO itself is not stable at 4V, the interfaces with coating materials are mostly unstable with high interfacial reaction energies as indicated by the black grids. For the 4 non-black grids, it simply indicates that there is no interfacial reaction between LLZO and the particular coating, with the energy showing the 4V instability of the coating material itself. For the coating materials that have the same decomposition energies interfacing LCO and NMC (and LLZO if non-black), in most cases the decomposition is from the intrinsic 4V instability of the coating materials due to a lack of the interfacial mutual reaction. We use K_{eff}=7 GPa in the screening here since LLZO itself is stabilized at 7 GPa at 4V. To achieve sufficient K_{eff}, a dense contact is required. Softer coatings, such as Li₂CO₃ that is also included in the FIGS. 7(a)-7(f) prediction with lower bulk modulus of 63 GPa and shear modulus of 32 GPa (documented in Materials Project), may be a good candidate for minimizing the complexity of oxide processing (such as requirement for high temperature sintering) and working for high-voltage stability. Note that Li₂CO₃ itself is ionically insulating, which is one reason why the spontaneous forming of Li₂CO₃ conformal coating on LLZO in air needs certain engineering^{[55]}, and boron doping that enables Li conduction can make it a good coating material^{[53]}. Another predicted Li₃PO₄ coating has also been experimentally examined between NMC811 and LLZTO to show high capacity and stable cycling.^{[54]}

### B.3 High-Throughput Search Under Constrained Ensemble for Li Halide Electrolyte Coating Materials

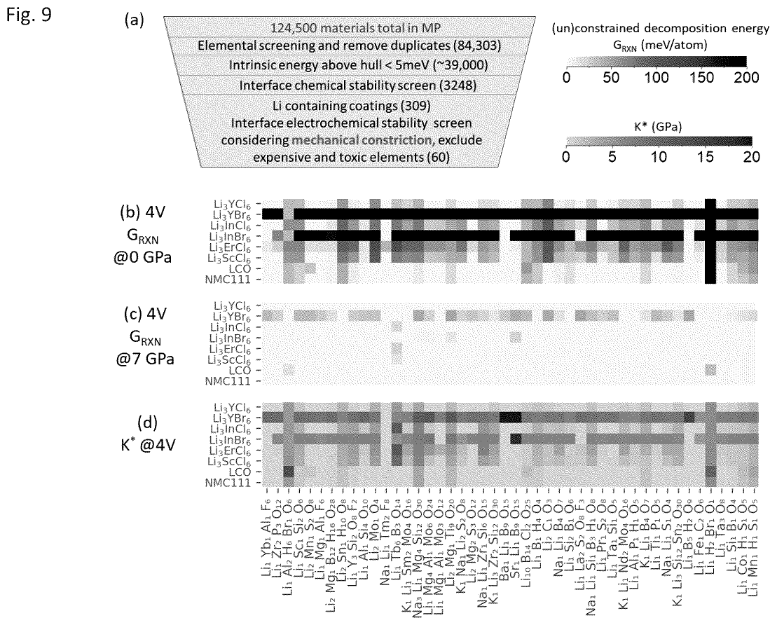

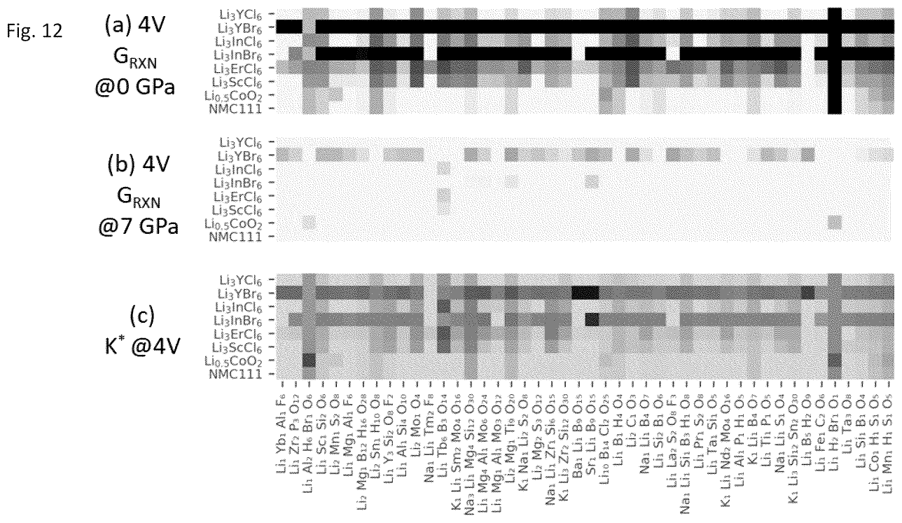

Similar screening procedure is used here for the interface between cathode and halide electrolyte. Most of the predicted coating materials for halide electrolytes are still oxides. When unconstrained (K_{eff}=0, FIG. 9(b)), Li₃YBr₆ and Li₃InBr₆ show unstable interfaces in most cases (dark color in FIG. 9(b)), because Li₃YBr₆ and Li₃InBr₆ are not stable at 4V, and they also have relatively large K* as shown in FIG. 9(d). To stabilize the interphase, a K_{eff}=7 GPa is applied in the last step of the high-throughput screening, since all 6 halide electrolytes themselves are stabilized at 7 GPa. We notice that non-solid Br₂ appears in most decomposition products of bromide/coating interfaces, and ClO₂ appears in 60% of the chloride/coating decomposition products, which won't really contribute to the solid reaction strain at RT that leads to the prediction above. Like the Li₃YCl₆ intrinsic stability case (FIG. 4), we add LiₓCl_{y} to possible decomposition products. The list is then shortened from 60 candidates to 46 (FIGS. 12(a)-12(c)), and 42% of the chloride/coating decomposition products includes LiₓCl_{y} (all LiCl₃), while ClO₂ appearance drops a little to 50%. Note that LiCl₃ and ClO₂ can coexist in a decomposition. ClO₂ may be reacted to form other new solid compounds such as LiₓCl_{y}O_{z} to contribute to the reaction strain. Similarly, other non-solid phases at RT (e.g., Br₂) might also end up as LiₓBr_{y} and LiₓBr_{y}O_{z}.

In this work, we systematically reinvestigated the voltage window response of mechanical constriction of different solid-state electrolytes. The oxidative limit of sulfide electrolytes can be opened to ˜4V, where kinetic stability can play an important role below 4V for the voltage stabilization. Oxide electrolytes can be opened to more than 6V if dense pellet can be achieved, where the additional role of plastic deformation in comparison with sulfides can be better evaluated in experiment. Halide materials have the highest window opening slope upon mechanical constriction, and LiₓCl_{y} phases may form during decomposition instead of the gas phase Cl₂.

By applying constrained ensemble to high-throughput search, we predicted several lists of coatings for Li cathode/electrolyte interfaces for sulfide, oxide, halide electrolytes. For interfaces between sulfide electrolytes and oxide cathodes, coatings with lower critical mechanical modulus K* than LiNbO₃ are predicted. LiNbO₃—LiCoO₂ interface shows better cyclability in solid state battery than in liquid battery in our experiment, giving experimental evidence of dynamic interface stability related to coating at the solid-solid interface. The fact that some batteries can cycle without coating can be explained by the more stable interfaces with chemically formed interphase during materials mixing. For oxide materials, potential coating materials that can act as electrochemically stable binder between cathode and garnet electrolyte are in the prediction list, including the existing B-doped Li₂CO₃ and Li₃PO₄. For halide materials, we discussed the possibility of forming LiₓCl_{y} at the interface with cathodes. Our work will shed light on the future design of electrolyte and electrode interface reaction by explicitly considering the effect of dynamic voltage stability. An application of the new design strategy in future experiments will further advance the performance of solid-state batteries.

### Methods

### 1. Constrained Ensemble Computational Approach

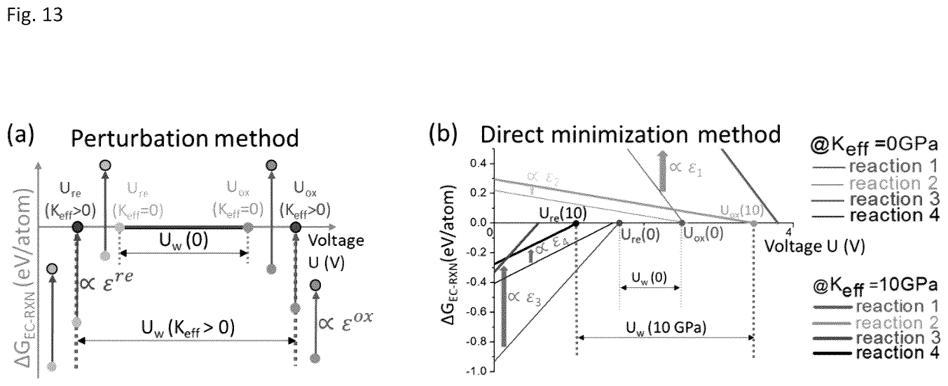

The computational modeling for constriction induced voltage stability is illustrated in FIGS. 13(a)-(b) for perturbation (13(a)) and minimization (13(b)) methods, respectively. We first consider a solid-state electrolyte (SSE) with stability window U_{w} (K_{eff}=0) between reduction limit Uᵣₑ (K_{eff}=0) and oxidation limit Uₒₓ (K_{eff}=0) when being unconstrained mechanically (K_{eff}=0). Above Uₒₓ(K_{eff}=0), oxidation decomposition will happen, where Li ion in solid-state electrolyte decomposes to Li metal. Below Uᵣₑ (K_{eff}=0), reductive decomposition will happen, where external Li metal source from anode is consumed. In perturbation method, at each voltage point we only consider one oxidative (reductive) reaction with the largest decomposition energy.^{[23]} The reaction equation, reaction strain ϵ, and reaction free energy ΔG_{EC-RXN} can be written as

$$SSE \to \sum {d}_{i} {Dec}_{i} + nLi \qquad ( 1 )$$

$$ϵ = \frac{\sum {d}_{i} {V}_{{Dec}_{i}} + {nV}_{Li} - {V}_{SSE}}{{V}_{SSE}} \qquad ( 2 )$$

$$Δ {G}_{BC - RXN} = {G}_{Dec} + n ( {G}_{Li} - eU ) - {G}_{SSE} + {K}_{eff} {V}_{SSE} ϵ \qquad ( 3 )$$

In eqn. (1), Decᵢ denotes the i^{th} decomposition product and dᵢ is its stoichiometry. In eqn. (2), the reaction strain is defined as the fraction of the difference between the final volume and the initial volume. Note that the reactant volume of Li metal in the reduction reaction at anode is not counted in the calculation of reaction strain, but Li metal product volume in the oxidative reaction at cathode is counted. Below the reduction limit, Li metal reactant is absorbed into the SSE to form the interface reaction decomposition, which contributes to the local volume expansion of the decomposition and the formation of the plastic strain field surrounding the decomposition reaction front that is of importance to the dynamic voltage stability of interest here. Since Li metal reactant initially is not inside the region of SSE, the volume of lithium metal reactant is thus not counted in the calculation of reaction strain that is inside SSE. Outside the region of the reaction front, Li⁺ ion and electron can still leave the anode region from the ion and electron reservoir to complete the reduction reaction as also required by the eU term in eq (3), which, however, does not influence the local positive reaction strain of the interface reaction, as all decomposition products are encapsulated by the ionically passivated reaction front layer. Similarly, beyond oxidation limit, although electron should go through outside circuit from cathode to anode side and then combine with a Li⁺ that is migrated from the Li reservoir at cathode to the anode, these electron and Li ion left the cathode are not from the reaction product of Li metal but from the reservoir outside the decomposition region encapsulated by the reaction front. Li⁺ ions as reaction product are trapped in the cathode decomposition region encapsulated by the ionically passivated reaction front layer, which then could combine with a neighboring electron to form Li metal. Li metal product in oxidative reaction thus contributes to the positive reaction strain.

In eqn. (3), G_{Dec}=ΣdᵢG_{Dec}_{ᵢ}, where G_{Dec}_{ᵢ} is the phase energy calculated by DFT obtained from the Materials Project. U is the voltage and the term K_{eff}V_{SSE}ε denotes the mechanical constriction effect where K_{eff} is the effective bulk modulus,^{[23]} V_{SSE} is the volume of solid electrolyte and e is the reaction strain, so at a given K_{eff}, the positive increase of reaction energy is proportional to reaction strain. FIG. 13(a) depicts the relationship described by eqn. (3). The rimless blue or red dots show the reductive or oxidative decomposition energy at each voltage point at K_{eff}=0, while the rimmed dots show the constrained decomposition energy. The upward arrow represents the magnitude of energy increase calculated from K_{eff}V_{SSE}ε.

At K_{eff}>0, if ΔG_{C-RXN}(U) is moved from negative to positive values due to the positive K_{eff}V_{SSE}ε, then the decomposition will not happen anymore, and the voltage U will be included into the expanded voltage window. Thus, the new voltage ranges from Uᵣₑ (K_{eff}>0) to Uₒₓ(K_{eff}>0) defined by the two new reactions in FIG. 13(a) is the voltage window U_{w} (K_{eff}>0) under certain mechanical constriction. In general, the voltage stability window U_{w} can be defined as:

$${U}_{w} ( {K}_{eff} ) = {U}_{ox} ( {K}_{eff} ) - {U}_{re} ( {K}_{eff} ) \qquad ( 4 )$$

The perturbation method only considers reactions with the largest decomposition energy, so that it is computationally effective. However, there are often more than one decomposition reactions competing in the reaction space with various reaction strains, which means other decomposition reactions with smaller positive reaction strains or even negative reaction strains that are neglected in the perturbation method could happen at voltages between Uᵣₑ (0) and Uᵣₑ (K_{eff}>0), and between Uₒₓ (0) and Uₒₓ (K_{eff} >0).

A more robust approach named direct minimization method is used to consider all reactions in the reaction space.^{[23]} FIG. 13(b) shows an example of implementing minimization method to calculate the voltage window of LGPS. One pair of oxidative and reductive decompositions decide the voltage window at a given K_{eff}. Electrochemical reaction energy of two pairs of decompositions corresponding to K_{eff}=0 GPa and K_{eff}=10 GPa are plotted in FIG. 13(b) as a straight line in the ΔG_{EC-RXN}-U space defined by eqn. (3), whose reaction equations can be expressed in the form of eqn. (1) as following:

$${Li}_{10} {GeP}_{2} {S}_{12} = 10 Li + 3 S + {P}_{2} {S}_{7} + {GeS}_{2} \qquad Reaction 1$$

$${Li}_{10} {GeP}_{2} {S}_{12} = 1.2 Li + 0.2 S + 0.2 {P}_{2} {S}_{7} + 0.2 {Li}_{4} {GeS}_{4} + 0.8 {Li}_{10} {GeP}_{2} {S}_{12} \qquad Reaction 2$$

$${Li}_{10} {GeP}_{2} {S}_{12} = 12 {Li}_{2} S + Ge + 2 P - 14 Li \qquad Reaction 3$$

$${Li}_{10} {GeP}_{2} {S}_{12} = 6.86 {Li}_{2} S + 0.19 {GeP}_{3} + 0.81 GeS + 1.44 {Li}_{2} {PS}_{3} - 6.6 Li \qquad Reaction 4$$

The x-interceptions of the reaction energy straight lines are the stability voltage limits, which can be expressed by equating eqn. (4) to 0:

$$U = ( {G}_{Dec} + {nG}_{Li} - {G}_{SSE} + {K}_{eff} {V}_{SSE} ε ) / ( ne ) \qquad ( 5 )$$

The slope is the negative stoichiometry of Li (−n) in the eqn. (3), and the positive increase of the decomposition energy by mechanical constriction is proportional to reaction strain ε, therefore the horizontal shifts are proportional to their ε/n. If the reaction strain is negative, void will form and the constriction effect will disappear locally, thus the K_{eff}V_{SSE}ε term will become 0 instead of being negative. This means the voltage window will not change, or equivalently we can define ε=0 in this case.

Reactions 1 and 2 are oxidative decompositions, and reactions 3 and 4 are reductive decompositions. Reactions 1 and 3 decide the voltage window at K_{eff}=0 GPa, and the reactions 2 and 4 decide the voltage window at K_{eff}=10 GPa. Other reactions in the reaction space besides these four are not discussed here since it turns out that they do not determine the voltage window for LGPS here. But we should keep in mind that they do exist in the energy landscape, and solid-state electrolyte can decompose into other products if different voltage and K_{eff} values are applied, or nonequilibrium decomposition pathways override such thermodynamic metastable decompositions.

For this specific case illustrated in FIG. 13(b), at K_{eff}=0 GPa, started from any voltage inside the voltage window, when scanning the voltage towards 0 V, the x-interception Uᵣₑ (0) will be met first, where all other reactions (e.g., reaction 4) in the reaction space except reaction 3 have positive reaction energy so that they are thermodynamically prohibited. Slightly below that voltage Uᵣₑ (0), the energy of reaction 3 becomes negative so LGPS become unstable and will decompose to Li₂S, Ge and P. Thus Uᵣₑ (0) is the reductive limit of LGPS at K_{eff}=0 GPa.

When increasing K_{eff} to 10 GPa, the energy of all reactions will increase proportionally to their reaction strain (if positive) as described by eqn. (3) and indicated by the 4 arrows in FIG. 13(b). Reaction 3 with reaction strain as large as 25% increases a lot as indicated by the long blue arrow. When scanning voltage towards 0 V at K_{eff}=10 GPa, the x-interception Uᵣₑ (10) belonging to reaction 4 will be met first instead. Reaction 4 has slightly more positive ΔG_{EC-RXN} than reaction 3 at K_{eff}=0 GPa below Uᵣₑ (0), but after applying mechanical constriction of K_{eff}=10 GPa, its much smaller reaction strain of 6% causes a much smaller positive increase of energy. Note that the slope (−n) of the energy line of reaction 4 (−n₄=6.6) is smaller than that of reaction 3 (−n₃=14), and the horizontal shift of x-interception is proportional to e/n. The fact that the x-interception of reaction 4 is to the right of the x-interception of reaction 3 at K_{eff}=10 GPa is mainly due to the much smaller reaction strain of reaction 4 than reaction 3. The competition between the two oxidization reactions 1 and 2 controlled by K_{eff} follows a similar discussion.

With the illustration discussed above, we can more generally define Uᵣₑ (K_{eff}) and Uₒₓ (K_{eff}). Each decomposition reaction has a n value, so we can scan n to scan all decompositions:

$${U}_{re} ( {K}_{eff} ) = {max}_{n < 0} [ ( {G}_{Dec} + {nG}_{Li} - {G}_{SSE} + {K}_{eff} {V}_{SSE} ε ) / ( ne ) ] \qquad ( 6 )$$

$${U}_{ox} ( {K}_{eff} ) = {min}_{n > 0} [ ( {G}_{Dec} + {nG}_{Li} - {G}_{SSE} + {K}_{eff} {V}_{SSE} ε ) / ( ne ) ] \qquad ( 7 )$$

A pseudo-phase^{[12]} composed of x coating and (1−x) SSE is denoted as pp(x). DFT phase energy Gₚₚ₍ₓ₎, composition x, and volume Vₚₚ₍ₓ₎ of the pp(x) are interpolated from coating and SSE. Equation (3) can then be rewritten as

$$Δ {G}_{EC - RXN} ( x ) = {G}_{Dec} + n ( {G}_{Li} - eU ) - {G}_{pp ( x )} + {K}_{eff} {V}_{SSE} ε \qquad ( 8 )$$

Let equation (8) equal to zero, it gives the critical K_{eff}, i.e., K_{crit}, that prohibits the electrochemical decomposition of the interface, and the maximum value of K_{crit}(x) to prevent decomposition at all x composition is defined as K*:

$${K}_{crit} ( x ) = - \frac{{G}_{Dec} + n ( {G}_{Li} - U ) - {G}_{pp ( x )}}{{V}_{pp ( x )} {ε}_{x}} \qquad ( 9 )$$

$${K}^{*} = max {K}_{crit} ( x ) \qquad ( 10 )$$

More detailed illustration regarding pseudo-phase approach and critical modulus K* by a computational example can be found in FIGS. 11(a)-11(c).

TABLE 2
LGPS 4V stability
LGPS 4V stability (Reference Volume = VLGPS)

| | decomposition | | |
|---|---|---|---|
| K_{eff} (GPa) | energy (eV/atom) | strain | Decomposition products |
| 0 | 0.988 | 0.302 | 10 Li + 3 S + P2S7 + 1 GeS2 |
| 10 | 0.183 | 0.264 | 8.8 Li + 2.4 S1 + P2S7 + |
| | | | 0.7 Ge1S2 + 0.3 Li4Ge1S4 |
| 20 | 0.000 | 0.000 | Li10Ge1P2S12 |

As shown in Table 2, without mechanical constriction, LGPS decomposition leads to 30.2% reaction strain with 0.988 eV/atom decomposition energy. When we assign K_{eff}εV_{LGPS} energy penalty to each reaction with different reaction strain ε, the sequence of the decomposition energy magnitude in the reaction space changes. Reactions with larger ε will have larger K_{eff}εV_{LGPS} penalty, thus increasing K_{eff} will make reactions with smaller ε have larger decomposition energy in the reaction space, leading to a change of ground state reaction toward smaller ε with increasing K_{eff}. At K_{eff}=20 GPa, LGPS does not decompose, suggesting a critical K_{eff} (i.e., K_{crit} or K*) between 10 GPa and 20 GPa, beyond which there is no oxidative decomposition reaction for LGPS.

Technically, when K_{eff} is small, perturbation method (see Methods) is approximately equal to minimization method. We know that in perturbation method, only the decomposition reaction with the highest reaction energy at 0 GPa is considered, so we take the derivative of equation (5) in Methods with respect to the K_{eff} for both oxidation reaction and reduction reaction:

$${{U}^{′} ( {K}_{eff} )}_{ox} = \frac{{V}_{SSE} {ε}_{ox}}{{n}_{ox} e} = {k}_{ox} \qquad ( A )$$

$${{U}^{′} ( {K}_{eff} )}_{re} = \frac{{V}_{SSE} {ε}_{re}}{{n}_{re} e} = {k}_{re} \qquad ( B )$$

Equations. (A) and (B) show that the volume of the electrolyte, the reaction strain, and the number of charge (or Lithium) transferred together decide the kₒₓ and kᵣₑ. For example, comparing the kₒₓ between Li₃YCl₆ and LGPS, Li₃YCl₆ shows 13% larger atomic volume, 28% larger reaction strain and 33% larger 1/nₒₓ that in the end gives 92% larger kₒₓ, which is very close to the 100% larger kₒₓ calculated by the minimization method (FIG. 2(d), Table 3).

TABLE 3
Summary of the ionic conductivity and computation results of the electrolytes.

| | σ_{ionic} | log | | | | | intrinsic | |
|---|---|---|---|---|---|---|---|---|
| Electrolyte | (mS/cm) | σ_{ionic} | R_{w} | kₒₓ | kᵣₑ | kₒₓ − kᵣₑ | window | reference |
| Li₁₀Ge(PS₆)₂ | 12 | −1.92 | 0.19 | 0.09 | −0.06 | 0.15 | 0.80 | ^{[27]} |
| Li₁₀Sn(PS₆)₂ | 4 | −2.40 | 0.14 | 0.08 | −0.02 | 0.10 | 0.70 | ^{[28]} |
| Li₇P₃S₁₁ | 17 | −1.77 | 0.26 | 0.09 | −0.07 | 0.16 | 0.60 | ^{[29]} |
| Li₁₀Si(PS₆)₂ | 23 | −1.64 | 0.14 | 0.08 | −0.05 | 0.13 | 0.90 | ^{[30]} |
| Li₂₀Si₃P₃S₂₃Cl | 25 | −1.60 | 0.15 | 0.07 | −0.05 | 0.12 | 0.80 | ^{[31]} |
| Li₃PS₄ | 0.16 | −3.80 | 0.18 | 0.08 | −0.06 | 0.14 | 0.80 | ^{[13]} |
| Li_{5.5}PS_{4.5}Cl_{1.5} | 12 | −1.92 | 0.20 | 0.10 | −0.07 | 0.16 | 0.80 | ^{[33]} |
| Li₃Ycl₆ | 0.5 | −3.30 | 0.09 | 0.18 | −0.13 | 0.31 | 3.60 | ^{[6]} |
| Li₃Ybr₆ | 1.7 | −2.77 | 0.10 | 0.12 | −0.15 | 0.27 | 2.60 | ^{[34]} |
| Li₃ErCl₆ | 0.3 | −3.52 | 0.10 | 0.20 | −0.16 | 0.36 | 3.40 | ^{[7]} |
| Li₃InCl₆ | 1.49 | −2.83 | 0.14 | 0.17 | −0.12 | 0.29 | 2.10 | ^{[33]} |
| Li₃ScCl₆ | 3 | −2.52 | 0.08 | 0.16 | −0.13 | 0.29 | 3.50 | ^{[35]} |
| Li_{1.3}Al_{0.3}Ti_{1.7}(PO₄)₃ | 0.7 | −3.15 | 0.10 | 0.14 | −0.10 | 0.24 | 2.30 | ^{[36]} |
| Li_{0.5}La_{0.5}TiO₃ | 1.08 | −3.24 | 0.03 | 0.08 | 0.00 | 0.08 | 2.50 | ^{[37]} |
| Li₇La₃Zr₂O₁₂ | 0.5 | −3.30 | 0.06 | 0.07 | −0.10 | 0.17 | 3.00 | ^{[38]} |
| Li₃Ocl | 0.85 | −3.07 | 0.03 | 0.10 | 0.00 | 0.10 | 2.80 | ^{[39]} |

In calculating the stability of interface and the effect of mechanical constriction, the pseudo-phase method^{[12]} is adopted to interpolate the phase energy, composition and volume of two phases. The solid black curve in FIG. 11(a) is an example of using the pseudo-phase method to calculate the interface hull of Li_{5.5}PS_{4.5}Cl_{1.5} and LiAlO₂. The dashed line interpolates the hull of Li_{5.5}PS_{4.5}Cl_{1.5} and LiAlO₂, showing the part of instability of the interface contributed by the intrinsic instability of the two ends. If the hull is below the dashed line, there is interfacial reaction between the two ends, which is the case of the (Li_{5.5}PS_{4.5}Cl_{1.5}—LiAlO₂) interface shown here. The Interface hull is defined as the most negative hull among all the composition x in the solid black curve. But due to large decomposition energy of sulfide electrolyte, the interface hull will be the hull of sulfide electrolyte itself in most cases, which does not reveal the meaningful information of the interface, therefore we apply certain K_{eff} (20 gPa here) to stabilize the electrolyte by raising the Li_{5.5}PS_{4.5}Cl_{1.5} decomposition reaction energy to be positive and keeping the energy of Li_{5.5}PS_{4.5}Cl_{1.5} itself unchanged, so the difference between the hull curve of (Li_{5.5}PS_{4.5}Cl_{1.5}—LiAlO₂) and (Li_{5.5}PS_{4.5}Cl_{1.5}@20gPa-LiAlO₂) is the difference in hull at the end point of Li_{5.5}PS_{4.5}Cl_{1.5}. From x=0 to x=0.1, the metastability of the Li_{5.5}PS₄Cl_{1.5} is perturbed by the interfacial reaction, thus the large decomposition energy. The interface hull then shifts from that of the Li_{5.5}PS_{4.5}Cl_{1.5} end point to that of x=0.1.

Treating pseudo phase at each composition x (pp(x)) as a solid-state electrolyte and using ΔG_{EC-RXN}=G_{Dec}+n(G_{Li}−eU)−G_{SSE}+K_{eff}V_{SSE}ε (eqn. 2 in Methods), we can evaluate the constriction induced voltage stability of the interface. Each pp(x) has its own G_{Dec}, n, Gₚₚ₍ₓ₎, Vₓ and εₓ. FIG. 11(b) shows how 35 gPa mechanical constriction affects the hull of {Li_{5.5}PS_{4.5}Cl_{1.5}@20 gPa-LiAlO₂) interface. For example, at x=0.2, when being normalized to 1 closed atom per formula, the volume V( 1/7 Li_{5.5}PS_{4.5}Cl_{1.5})=128.78 Å³/closed atom, and the volume V(⅓ LiAlO₂)=13.806 Å³/closed atom, thus at x=0.2, the pseudo phase volume V_{0.2}=0.2*V(⅓ LiAlO₂)+0.8*V( 1/7 Li_{5.5}PS_{4.5}Cl_{1.5})=0.2*13.806+0.8*128.78=105.79 Å³/closed atom. K_{eff}V_{0.2}ε_{0.2} well exceeds the hull and brings the decomposition reaction energy to ˜+1 eV as shown by the long red arrow, so that the decomposition is suppressed and the hull at x=0.2 becomes 0 by definition. At x=0.9, however, the K_{eff}V_{0.2}ε_{0.2} is not large enough to bring the decomposition energy to be positive, thus the interface can still decompose at K_{eff}=35 gPa, but the decomposition energy is much smaller, suggesting a more stable {Li_{5.5}PS_{4.5}Cl_{1.5}—LiAlO₂) interface. We define K_{crit}(x) to demonstrate the level of mechanical constriction just needed to suppress decomposition reaction of pp(x) as shown in FIG. 11(b) by the thick green arrow at x=0.9 and the black arrow at x=0.2, which is the K_{eff} value to equate eqn. (8) in the main text to 0 and gives eqn. (9).

At composition x, the particular decomposition reaction is suppressed if and only if K_{eff} >K_{crit}_{ₓ}. As K_{crit} is a function of x, therefore, to suppress the reaction between two phases, the largest K_{crit}(x) must be reached. We define the largest K_{crit}(x) to be K′ (eqn. 10). FIG. 11(c)) shows the K_{crit} of {Li_{5.5}PS_{4.5}Cl_{1.5}—LiAlO₂) interface at 4V and labels the K′. The K_{eff}Vₓεₓ is also plotted in FIG. 11(c) and shows a minimum at x=0.9, coinciding the x for maximum K_{crit}_{ₓ}. From FIG. 11(a), the absolute value of hull at x=0.9 is actually the smallest among the hull from x=0.1 to x=0.9, but due to its smallest Vₓεₓ (or smallest K_{eff}Vₓεₓ), the K_{crit}(0.9) becomes the largest K_{crit}(x), suggesting that the smallest mechanical response is at x=0.9.

### Battery

Li_{5.5}PS_{4.5}Cl_{1.5}, was prepared by ball milling and solid state reactions. Stoichiometric amounts of Li₂S (99.9% purity, Alfa Aesar), P₂S₅(99% purity, Sigma Aldrich), and LiCl (>99% purity, Alfa Aesar) were milled for 16 hours under argon protection. The precursor was transferred into a quartz tube and annealed at 550° C. for 1 hour with a temperature increasing rate of 5° C./min in an argon gas flow. LiNi_{0.83}Mn_{0.06}Co_{0.11}O₂ (NMC811) and LGPS (325 mesh) are purchased from MSE. LiCoO₂ is purchased from Sigma Aldrich.

Solid state batteries were made with the configuration of Li/graphite-solid electrolyte layer(s)-cathode matrix. The Li metal foil of 0.63 cm diameter and 25 μm thickness (0.42 mg, 1.62 mAh, 5.2 mAh/cm²) was covered by a graphite thin film of 0.95 cm diameter to act as the anode. The graphite layer was made by mixing 95 wt % graphite (BTR, China) with 5 wt % PTFE, and the capacity ratio of lithium to graphite is 2.5:1. 30 mg LPSCl (120 μm thickness) and 100 mg central layer powder (400 μm thickness) were applied as the electrolyte. A 60 mg separating layer (240 μm) of the same electrolyte powder in the cathode matrix is added when the central layer is different from that in the cathode matrix. LiNbO₃ (LNO) is coated on LiNi_{0.83}Mn_{0.06}Co_{0.11}O₂ (NMC811) or LiCoO₂ (LCO) by 1.9 wt % following previous report^{[46]}. 70 wt % bare 811, bare LCO, or LNO coated 811 or LiCoO₂ was mixed with 30 wt % LPSCl or LGPS to serve as the cathode with an additional 3% PTFE to make a cathode film. The loading of the cathode is kept at 2 mg/cm² for all the battery tests. The battery was initially pressed at 460 MPa and a stack pressure of 150 MPa was maintained by a pressurized cell. The batteries were cycled at 55° C. or room temperature on an Arbin battery testing station in an environmental chamber with the humidity controlled <10% inside Memmert hpp110, 1 C-rate=150 mA/g in this work. Liquid electrolyte batteries used glass fiber as separator and 1 M LiPF6 in EC/DMC (v:v=1:1) as electrolyte. Li metal is used as anode. The powder of cathode active material, carbon black, and PTFE are mixed with weight ratio of 85:10:5 and then roll into a thin film with diameter of 5/16″, and then assembled in a Swagelok cell.

### REFERENCE

[1] Y. Chen, Z. Wang, X. Li, X. Yao, C. Wang, Y. Li, W. Xue, D. Yu, S. Y. Kim, F. Yang, A. Kushima, G. Zhang, H. Huang, N. Wu, Y.-W. Mai, J. B. Goodenough, J. Li, Nature 2020, 578, 251.
[2] Y.-G. Lee, S. Fujiki, C. Jung, N. Suzuki, N. Yashiro, R. Omoda, D.-S. Ko, T. Shiratsuchi, T. Sugimoto, S. Ryu, J. H. Ku, T. Watanabe, Y. Park, Y. Aihara, D. Im, I. T. Han, Nature Energy 2020, 5, 299.
[3] L. R. Mangani, C. Villevieille, J. Mater. Chem. A 2020, 8, 10150.
[4] L. Ye, X. Li, Nature 2021, 593, 218.
[5] L. Ye, W. Fitzhugh, E. Gil-González, Y. Wang, Y. Su, H. Su, T. Qiao, L. Ma, H. Zhou, E. Hu, X. Li, Adv. Energy Mater. 2020, 10, 2001569.
[6] T. Asano, A. Sakai, S. Ouchi, M. Sakaida, A. Miyazaki, S. Hasegawa, Adv. Mater. 2018, 30, 1803075.
[7] X. Li, J. Liang, J. Luo, M. N. Banis, C. Wang, W. Li, S. Deng, C. Yu, F. Zhao, Y. Hu, Energy Environ. Sci. 2019, 12, 2665.
[8] Y. Xiao, L. J. Miara, Y. Wang, G. Ceder, Joule 2019, 3, 1252.
[9] Y. Zhu, X. He, Y. Mo, ACS Appl. Mater. Interfaces 2015, 7, 23685.
[10] S. P. Ong, Y. Mo, W. D. Richards, L. Miara, H. S. Lee, G. Ceder, Energy Environ. Sci. 2013, 6, 148.
[11] S. Wang, Q. Bai, A. M. Nolan, Y. Liu, S. Gong, Q. Sun, Y. Mo, Angew. Chem. Int. Ed. 2019, 58, 8039.
[12] W. D. Richards, L. J. Miara, Y. Wang, J. C. Kim, G. Ceder, Chem. Mater. 2016, 28, 266.
[13] F. Du, X. Ren, J. Yang, J. Liu, W. Zhang, J. Phys. Chem. C 2014, 118, 10590.
[14] T. K. Schwietert, V. A. Arszelewska, C. Wang, C. Yu, A. Vasileiadis, N. J. de Klerk, J. Hageman, T. Hupfer, I. Kerkamm, Y. Xu, Nat. Mater. 2020, 19, 428.
[15] Y. Wang, L. Ye, X. Chen, X. Li, JACS Au 2022, 2, 886.
[16] E. Gil-González, L. Ye, Y. Wang, Z. Shadike, Z. Xu, E. Hu, X. Li, Energy Storage Materials 2022, 45, 484.
[17] J. Sung, S. Y. Kim, A. Harutyunyan, M. Amirmaleki, Y. Lee, Y. Son, J. Li, Adv. Mater. 2023, 2210835.
[18] J. Woo, Y. B. Song, H. Kwak, S. Jun, B. Y. Jang, J. Park, K. T. Kim, C. Park, C. Lee, K. H. Park, Adv. Energy Mater. 2023, 13, 2203292.
[19] D. H. S. Tan, Y.-T. Chen, H. Yang, W. Bao, B. Sreenarayanan, J.-M. Doux, W. Li, B. Lu, S.-Y. Ham, B. Sayahpour, J. Scharf, E. A. Wu, G. Deysher, H. E. Han, H. J. Hah, H. Jeong, J. B. Lee, Z. Chen, Y. S. Meng, Science 2021, 373, 1494.
[20] D. Cao, X. Sun, Y. Li, A. Anderson, W. Lu, H. Zhu, Adv. Mater. 2022, 34, 2200401.
[21] F. Wu, W. Fitzhugh, L. Ye, J. Ning, X. Li, Nat. Commun. 2018, 9, 1.
[22] W. Fitzhugh, F. Wu, L. Ye, H. Su, X. Li, Small 2019, 15, 1901470.
[23] W. Fitzhugh, L. Ye, X. Li, J. Mater. Chem. A 2019, 7, 23604.
[24] Y. Su, L. Ye, W. Fitzhugh, Y. Wang, E. Gil-González, I. Kim, X. Li, Energy Environ. Sci. 2020, 13, 908.
[25] F. P. McGrogan, T. Swamy, S. R. Bishop, E. Eggleton, L. Porz, X. Chen, Y. M. Chiang, K. J. Van Vliet, Adv. Energy Mater. 2017, 7, 1602011.
[26] W. Fitzhugh, X. Chen, Y. Wang, L. Ye, X. Li, Energy Environ. Sci. 2021, 14, 4574.
[27] N. Kamaya, K. Homma, Y. Yamakawa, M. Hirayama, R. Kanno, M. Yonemura, T. Kamiyama, Y. Kato, S. Hama, K. Kawamoto, Nat. Mater. 2011, 10, 682.
[28] P. Bron, S. Johansson, K. Zick, J. r. Schmedt auf der Günne, S. Dehnen, B. Roling, J. Am. Chem. Soc. 2013, 135, 15694.
[29] Y. Seino, T. Ota, K. Takada, A. Hayashi, M. Tatsumisago, Energy Environ. Sci. 2014, 7, 627.
[30] B. Zhang, L. Yang, L.-W. Wang, F. Pan, Nano Energy 2019, 62, 844.
[31] Y. Kato, S. Hori, T. Saito, K. Suzuki, M. Hirayama, A. Mitsui, M. Yonemura, H. Iba, R. Kanno, Nature Energy 2016, 1, 1.
[32] Z. Liu, W. Fu, E. A. Payzant, X. Yu, Z. Wu, N. J. Dudney, J. Kiggans, K. Hong, A. J. Rondinone, C. Liang, J. Am. Chem. Soc. 2013, 135, 975.
[33] P. Adeli, J. D. Bazak, K. H. Park, I. Kochetkov, A. Huq, G. R. Goward, L. F. Nazar, Angew. Chem. Int. Ed. 2019, 58, 8681.
[34] R. Schlem, S. Muy, N. Prinz, A. Banik, Y. Shao-Horn, M. Zobel, W. G. Zeier, Adv. Energy Mater. 2020, 10, 1903719.
[35] J. Liang, X. Li, S. Wang, K. R. Adair, W. Li, Y. Zhao, C. Wang, Y. Hu, L. Zhang, S. Zhao, J. Am. Chem. Soc. 2020, 142, 7012.
[36] H. Aono, N. Imanaka, G.-y. Adachi, Acc. Chem. Res. 1994, 27, 265.
[37] H. Geng, A. Mei, Y. Lin, C. Nan, Materials Science and Engineering: B 2009, 164, 91.
[38] R. Murugan, V. Thangadurai, W. Weppner, Angew. Chem. Int. Ed. 2007, 46, 7778.
[39] Y. Zhao, L. L. Daemen, J. Am. Chem. Soc. 2012, 134, 15042.
[40] Z. Xu, X. Chen, H. Zhu, X. Li, Adv. Mater. 2022, 34, 2207411.
[41] S. Muy, J. C. Bachman, L. Giordano, H.-H. Chang, D. L. Abernathy, D. Bansal, O. Delaire, S. Hori, R. Kanno, F. Maglia, Energy Environ. Sci. 2018, 11, 850.
[42] Y. Gao, S. Sun, X. Zhang, Y. Liu, J. Hu, Z. Huang, M. Gao, H. Pan, Adv. Funct. Mater. 2021, 31, 2009692.
[43] M. Braga, J. A. Ferreira, V. Stockhausen, J. Oliveira, A. El-Azab, J. Mater. Chem. A 2014, 2, 5470.
[44] X. LO, J. W. Howard, A. Chen, J. Zhu, S. Li, G. Wu, P. Dowden, H. Xu, Y. Zhao, Q. Jia, Advanced Science 2016, 3, 1500359.
[45] W. Zhang, A. R. Oganov, A. F. Goncharov, Q. Zhu, S. E. Boulfelfel, A. O. Lyakhov, E. Stavrou, M. Somayazulu, V. B. Prakapenka, Z. Konôpková, Science 2013, 342, 1502.
[46] F. Xin, H. Zhou, X. Chen, M. Zuba, N. Chernova, G. Zhou, M. S. Whittingham, ACS Appl. Mater. Interfaces 2019, 11, 34889.
[47] F. Xin, H. Zhou, Y. Zong, M. Zuba, Y. Chen, N. A. Chernova, J. Bai, B. Pei, A. Goel, J. Rana, ACS Energy Letters 2021, 6, 1377.
[48] J. S. Lee, Y. J. Park, ACS Appl. Mater. Interfaces 2021, 13, 38333.
[49] S. H. Jung, K. Oh, Y. J. Nam, D. Y. Oh, P. Bruner, K. Kang, Y. S. Jung, Chem. Mater. 2018, 30, 8190.
[50] E. A. Wu, C. Jo, D. H. Tan, M. Zhang, J.-M. Doux, Y.-T. Chen, G. Deysher, Y. S. Meng, J. Electrochem. Soc. 2020, 167, 130516.
[51] K. J. Kim, J. L. Rupp, Energy Environ. Sci. 2020, 13, 4930.
[52] K. Park, B.-C. Yu, J.-W. Jung, Y. Li, W. Zhou, H. Gao, S. Son, J. B. Goodenough, Chem. Mater. 2016, 28, 8051.
[53] F. Han, J. Yue, C. Chen, N. Zhao, X. Fan, Z. Ma, T. Gao, F. Wang, X. Guo, C. Wang, Joule 2018, 2, 497.
[54] Z. Zhao, Z. Wen, X. Liu, H. Yang, S. Chen, C. Li, H. Lv, F. Wu, B. Wu, D. Mu, Chem. Eng. J. 2021, 405, 127031.
[55] H. Huo, J. Luo, V. Thangadurai, X. Guo, C.-W. Nan, X. Sun, ACS Energy Letters 2019, 5, 252.

Other embodiments are in the claims.

What is claimed is:

1. A compound from Table 1:
TABLE 1

| Compound | Chemical formula |
|---|---|
| 1 | Ba₁Li₁B₁O₃ |
| 2 | Ba₁Li₁B₉O₁₅ |
| 3 | Ba₁Na₁Li₃B₆O₁₂ |
| 4 | Ba₂Li₁I₁O₆ |
| 5 | Ba₂Li₂Zr₄F₂₂ |
| 6 | Ba₂Na₂Li₆B₁₂O₂₄ |
| 7 | Ba₄Li₁Bi₃O₁₂ |
| 8 | Ba₄Li₁Nb₃O₁₂ |
| 9 | Ba₄Li₁Ta₃O₁₂ |
| 10 | Ba₄Li₄Al₄F₂₄ |
| 11 | Ba₄Li₈P₈O₂₈ |
| 12 | Ba₅Li₂W₃O₁₅ |
| 13 | Ba₆Li₄B₂₀H₁₂O₄₄ |
| 14 | K₁Li₁B₄O₇ |
| 15 | K₁Li₁C₁O₃ |
| 16 | K₁Li₁Nd₂Mo₄O₁₆ |
| 17 | K₁Li₁S₁O₄ |
| 18 | K₁Li₁Sm₂Mo₄O₁₆ |
| 19 | K₁Li₃Si₁₂Sn₂O₃₀ |
| 20 | K₁Li₃Zr₂Si₁₂O₃₀ |
| 21 | K₁Na₁Li₂S₂O₈ |
| 22 | K₁Na₂Li₃Fe₂Si₁₂O₃₀ |
| 23 | K₂Li₁Sc₁F₆ |
| 24 | K₂Li₁V₁O₄ |
| 25 | K₂Li₂Si₄O₁₀ |
| 26 | K₂Li₆Ca₁₄Ti₄Si₂₄O₇₂F₄ |
| 27 | K₂Li₆Zr₄Si₂₄O₆₀ |
| 28 | K₄Li₁I₁O₆ |
| 29 | K₄Li₂Al₂F₁₂ |
| 30 | K₄Li₄Y₄F₂₀ |
| 31 | K₅Li₂Nd₁F₁₀ |
| 32 | K₅Li₂Pr₁F₁₀ |
| 33 | K₆Li₂Mg₈Si₂₄O₆₀ |
| 34 | K₈Li₁₂B₄P₁₆O₅₆ |
| 35 | K₈Li₄B₄P₈O₃₂ |
| 36 | K₈Li₈B₃₂₀₅₆ |
| 37 | Li₁Al₁P₁H₁O₅ |
| 38 | Li₁Al₁Si₄O₁₀ |
| 39 | Li₁Al₂H₆Br₁O₆ |
| 40 | Li₁B₁H₄O₄ |
| 41 | Li₁B₅H₂O₉ |
| 42 | Li₁Bi₁O₃ |
| 43 | Li₁Ca₁P₁O₄ |
| 44 | Li₁Ca₉Mg₁P₇O₂₈ |
| 45 | Li₁Cd₁B₁O₃ |
| 46 | Li₁Cl₁O₄ |
| 47 | Li₁Co₁H₁S₁O₅ |
| 48 | Li₁Co₁Ni₁O₄ |
| 49 | Li₁Co₁O₂ |
| 50 | Li₁Co₂O₄ |
| 51 | Li₁Eu₆B₃O₁₄ |
| 52 | Li₁F₁ |
| 53 | Li₁Fe₁C₂O₆ |
| 54 | Li₁Fe₁Si₂O₆ |
| 55 | Li₁Gd₆B₃O₁₄ |
| 56 | Li₁H₂Cl₁O₅ |
| 57 | Li₁H₃O₂ |
| 58 | Li₁H₆Br₁O₇ |
| 59 | Li₁La₂Fe₁O₆ |
| 60 | Li₁La₂S₂O₈F₃ |
| 61 | Li₁La₂Sb₁O₆ |
| 62 | Li₁La₃Mn₁O₇ |
| 63 | Li₁Mg₁Al₁F₆ |
| 64 | Li₁Mg₁Al₁Mo₃O₁₂ |
| 65 | Li₁Mg₄Al₁Mo₆O₂₄ |
| 66 | Li₁Mn₁H₁S₁O₅ |
| 67 | Li₁N₁O₃ |
| 68 | Li₁Nd₆B₃O₁₃F₂ |
| 69 | Li₁Ni₂O₃ |
| 70 | Li₁Ni₂O₄ |
| 71 | Li₁O₈ |
| 72 | Li₁Pr₁S₂O₈ |
| 73 | Li₁Sc₁Si₂O₆ |
| 74 | Li₁Si₁B₁O₄ |
| 75 | Li₁Si₂B₁O₆ |
| 76 | Li₁Ta₁Si₁O₅ |
| 77 | Li₁Ta₃O₈ |
| 78 | Li₁Ti₁P₁O₅ |
| 79 | Li₁Ti₄Mn₁P₆O₂₄ |
| 80 | Li₁Tm₁Si₁O₄ |
| 81 | Li₁Y₁Si₁O₄ |
| 82 | Li₁Y₃Si₂O₈F₂ |
| 83 | Li₁Yb₁Al₁F₆ |
| 84 | Li₁Zr₂P₃O₁₂ |
| 85 | Li₁₀B₁₄Cl₂O₂₅ |
| 86 | Li₁₀Co₁Ni₉O₂₀ |
| 87 | Li₁₀Fe₃Ni₇O₂₀ |
| 88 | Li₁₀Mg₁₂Fe₁P₁₂O₄₈ |
| 89 | Li₁₀Sc₉Fe₁Si₂₀O₆₀ |
| 90 | Li₁₂Al₄Si₄O₂₀ |
| 91 | Li₁₂B₂₀H₈O₄₀ |
| 92 | Li₁₂Mn₁₁Fe₁P₁₂O₄₈ |
| 93 | Li₁₂P₁₂O₃₆ |
| 94 | Li₁₂Sc₈P₁₂O₄₈ |
| 95 | Li₁₂Ta₄O₁₆ |
| 96 | Li₁₃Mg₁Ni₁₂O₂₆ |
| 97 | Li₁₃Ni₁₅O₂₈ |
| 98 | Li₁₄Nb₁₄O₄₂ |
| 99 | Li₁₆Mn₁₅Fe₁P₁₆O₆₄ |
| 100 | Li₁₆Mn₈P₁₆O₅₆ |
| 101 | Li₁₆P₈O₂₈ |
| 102 | Li₁₆Zr₄F₃₂ |
| 103 | Li₁₈Al₆F₃₆ |
| 104 | Li₁₉Ni₂₃O₄₂ |
| 105 | Li₂Al₂P₂H₂O₁₀ |
| 106 | Li₂Al₂Si₈O₂₀ |
| 107 | Li₂Al₄H₁₂Br₂O₁₂ |
| 108 | Li₂Al₄H₁₂Cl₂O₁₂ |
| 109 | Li₂C₁O₃ |
| 110 | Li₂Ca₁₈Mn₂P₁₄O₅₆ |
| 111 | Li₂Ca₂Al₂F₁₂ |
| 112 | Li₂Cd₁Si₁O₄ |
| 113 | Li₂Cl₂ |
| 114 | Li₂Co₁Ni₃O₈ |
| 115 | Li₂Co₁O₂F₁ |
| 116 | Li₂Co₃Ni₁O₈ |
| 117 | Li₂Dy₂P₈O₂₄ |
| 118 | Li₂Fe₁Co₃O₈ |
| 119 | Li₂Fe₁O₂F₁ |
| 120 | Li₂Fe₃Bi₁O₈ |
| 121 | Li₂Fe₃Sb₁O₈ |
| 122 | Li₂Gd₂P₈O₂₄ |
| 123 | Li₂Ho₂P₈O₂₄ |
| 124 | Li₂La₁N₅O₁₅ |
| 125 | Li₂La₂P₈O₂₄ |
| 126 | Li₂Mg₁B₁₂H₁₆O₂₈ |
| 127 | Li₂Mg₁TigO₂₀ |
| 128 | Li₂Mg₂S₃O₁₂ |
| 129 | Li₂Mn₁O₃ |
| 130 | Li₂Mn₁S₂O₈ |
| 131 | Li₂Mn₁₂P₁₄O₄₈ |
| 132 | Li₂Mn₄P₆O₂₀ |
| 133 | Li₂Nd₁N₅O₁₅ |
| 134 | Li₂Nd₂P₈O₂₄ |
| 135 | Li₂Ni₁O₃ |
| 136 | Li₂Pr₁N₅O₁₅ |
| 137 | Li₂S₁O₄ |
| 138 | Li₂Sc₁Fe₁Si₄O₁₂ |
| 139 | Li₂Sc₂P₄O₁₄ |
| 140 | Li₂Sc₂Si₄O₁₂ |
| 141 | Li₂Se₁O₄ |
| 142 | Li₂Si₁O₃ |
| 143 | Li₂Sm₂P₈O₂₄ |
| 144 | Li₂Sn₁H₁₀O₈ |
| 145 | Li₂Tb₂P₈O₂₄ |
| 146 | Li₂Ti₁O₃ |
| 147 | Li₂Ti₄P₆O₂₄ |
| 148 | Li₂Y₂F₈ |
| 149 | Li₂Y₂P₈O₂₄ |
| 150 | Li₂Y₆Si₄O₁₆F₄ |
| 151 | Li₂Yb₂Al₂F₁₂ |
| 152 | Li₂Zn₁Si₁O₄ |
| 153 | Li₂Zr₁F₆ |
| 154 | Li₃Al₁Si₁O₅ |
| 155 | Li₃B₃F₁₂ |
| 156 | Li₃Gd₁N₆O₁₈ |
| 157 | Li₃La₂H₆N₉O₃₀ |
| 158 | Li₃La₃MO₂O₁₂ |
| 159 | Li₃Mg₃Al₃F₁₈ |
| 160 | Li₃Nb₁O₄ |
| 161 | Li₃Nd₃W₂O₁₂ |
| 162 | Li₃P₁O₄ |
| 163 | Li₃Sb₁O₄ |
| 164 | Li₃Ta₁O₄ |
| 165 | Li₃Tb₁N₆O₁₈ |
| 166 | Li₃V₁O₄ |
| 167 | Li₃Yb₁N₆O₁₈ |
| 168 | Li₄Al₂₀O₃₂ |
| 169 | Li₄Al₄P₁₆O₄₈ |
| 170 | Li₄B₁₂O₁₈F₄ |
| 171 | Li₄Ca₃₆Mg₄P₂₈O₁₁₂ |
| 172 | Li₄Co₁Ni₃O₈ |
| 173 | Li₄H₈Br₄O₄ |
| 174 | Li₄Mg₁₂P₁₂O₄₄ |
| 175 | Li₄Mg₄P₄O₁₆ |
| 176 | Li₄Mn₄P₁₂O₃₆ |
| 177 | Li₄Mn₄P₄O₁₆ |
| 178 | Li₄Mo₁O₅ |
| 179 | Li₄P₄H₈O₁₆ |
| 180 | Li₄Sc₁Fe₃Si₈O₂₄ |
| 181 | Li₄Sc₂P₄H₂O₁₆ |
| 182 | Li₄Sc₄Si₄O₁₆ |
| 183 | Li₄Se₁O₅ |
| 184 | Li₄Si₂O₆ |
| 185 | Li₄Si₄O₁₀ |
| 186 | Li₄Ta₄Si₄O₂₀ |
| 187 | Li₄Ti₂F₁₂ |
| 188 | Li₄Ti₂Si₂O₁₀ |
| 189 | Li₄Ti₄P₄O₂₀ |
| 190 | Li₄Tm₄Si₄O₁₆ |
| 191 | Li₄W₁O₅ |
| 192 | Li₄Y₄Si₄O₁₆ |
| 193 | Li₄Zr₈P₁₂O₄₈ |
| 194 | Li₅I₁O₆ |
| 195 | Li₅Sc₂Fe₃Si₁₀O₃₀ |
| 196 | Li₆Al₆Si₆O₂₄ |
| 197 | Li₆B₁₄O₂₄ |
| 198 | Li₆Ca₆P₆O₂₄ |
| 199 | Li₆P₂O₈ |
| 200 | Li₆Sc₁Fe₃Si₁₂O₃₆ |
| 201 | Li₆Si₃F₁₈ |
| 202 | Li₆Ta₆O₉F₁₈ |
| 203 | Li₆Zr₈F₃₈ |
| 204 | Li₇Co₅O₁₂ |
| 205 | Li₇Ni₅O₁₂ |
| 206 | Li₈Al₆Si₆Cl₂O₂₄ |
| 207 | Li₈B₁₂O₁₆F₁₂ |
| 208 | Li₈B₁₆O₂₈ |
| 209 | Li₈B₈H₃₂O₃₂ |
| 210 | Li₈Ca₄B₃₂H₂₈O₇₀ |
| 211 | Li₈P₁₀H₂O₃₀ |
| 212 | Li₈Sc₁Fe₇Si₁₆O₄₈ |
| 213 | Li₈Sc₅Fe₃Si₁₆O₄₈ |
| 214 | Li₈Si₁₂O₂₈ |
| 215 | Li₈Si₁₆B₈O₄₈ |
| 216 | Li₈Ti₈P₁₂O₄₈ |
| 217 | Li₉Er₃Cl₁₈ |
| 218 | Li₉Ni₁₀O₂₀ |
| 219 | Na₁Li₁B₄O₇ |
| 220 | Na₁Li₁C₁O₃ |
| 221 | Na₁Li₁Fe₂Si₄O₁₂ |
| 222 | Na₁Li₁S₁O₄ |
| 223 | Na₁Li₁Si₁B₃H₁O₈ |
| 224 | Na₁Li₁Tm₂F₈ |
| 225 | Na₁Li₁Zr₁Si₆O₁₅ |
| 226 | Na₁Li₂P₁O₄ |
| 227 | Na₁Li₃Fe₄Si₈O₂₄ |
| 228 | Na₁Li₇Fe₈Si₁₆O₄₈ |
| 229 | Na₁Li₉Fe₁₀Si₂₀O₆₀ |
| 230 | Na₁₂Li₁₂Al₈F₄₈ |
| 231 | Na₁₂Li₁₂Sc₈F₄₈ |
| 232 | Na₁₆Li₈Al₈P₁₆H₁₆O₇₂ |
| 233 | Na₂Li₁Al₁F₆ |
| 234 | Na₂Li₂Er₄F₁₆ |
| 235 | Na₂Li₂Ho₄F₁₆ |
| 236 | Na₂Li₂Tm₄F₁₆ |
| 237 | Na₂Li₂Y₄F₁₆ |
| 238 | Na₂Li₄B₂P₄O₁₆ |
| 239 | Na₃Li₁Fe₄Si₈O₂₄ |
| 240 | NasLi₁Mg₄Si₁₂O₃₀ |
| 241 | Na₃Li₁W₁O₅ |
| 242 | Na₃Li₂Fe₅Si₁₀O₃₀ |
| 243 | Na₄Li₄B₁₆O₂₈ |
| 244 | Na₄Li₄Mg₄P₄O₁₆F₄ |
| 245 | Na₄Li₄Si₄B₁₂H₄O₃₂ |
| 246 | Na₄Li₄Zr₄Si₂₄O₆₀ |
| 247 | Na₄Li₈P₄O₁₆ |
| 248 | NasLi₁Fe₆Si₁₂O₃₆ |
| 249 | NasLi₁P₂O₈ |
| 250 | Na₆Li₂Mg₈Si₂₄O₆₀ |
| 251 | Na₈Li₄Y₄Si₂₄O₆₀ |
| 252 | Na₉Li₁Fe₁₀Si₂₀O₆₀ |
| 253 | Sr₁Li₁B₉O₁₅ |
| 254 | Sr₂Li₂Al₂F₁₂ |
| 255 | Sr₈Li₂B₂₂H₂O₄₃ |
| 256 | Sr₈Li₄B₂₄O₄₆ |

2. A solid state battery comprising:
a) an anode and a cathode comprising cathode particles and solid state electrolyte particles; and
b) a solid state electrolyte separating the anode and cathode; and
c) an interface coating layer between the cathode particles and the solid state electrolyte particles wherein the interface coating layer comprises a compound of claim 1.

3. The battery of claim 2, wherein the anode comprises Li metal.

4. The battery of claim 3, wherein the anode further comprises Li, Na, Mg, Al, Si, K, Ca, Sc, Ti, V, Cr, Mn, Fe, Co, Ni, Cu, Zn, Ga, Ge, As, Rb, Sr, Y, Zr, Nb, Mo, Ag, Cd, In, Sn, Sb, Bi, Cs, Te, or a combination thereof.

5. The battery of claim 2, wherein the cathode comprises LiNi_{0.8}Mn_{0.1}Co_{0.1}O₂ (NMC811), LiNi_{0.93}Mn_{0.33}CO_{0.33}O₂ (NMC111), LiNi_{0.5}Mn_{0.3}Co_{0.2}O₂ (NMC532), LiNi_{0.8}Mn_{0.2}Co_{0.2}O₂ (NMC622), LiNi_{0.9}Mn_{0.05}Co_{0.05}O₂ (NMC955), LiNiₓMn_{y}Co_{(1-x-y)}O₂ (0≤x,y≤1), LiNiₓCo_{y}Al_{(1-x-y)}O₂ (0≤x,y≤1), LiMn₂O₄, LiMnO₂, LiNiO₂, Li_{1-z}NiₓMn_{y}Co_{(1-x-y-z)}O₂ (0≤x,y,z≤1), Li_{1-z}NiₓMn_{y}Co_{w}Al_{(1-x-y-z)}O₂ (0≤x,y,z,s≤1), Li_{1+z}NiₓMn_{y}CoₛW_{(1-x-y-z-s)}O₂ (0≤x,y,z,w≤1), V₂O₅, selenium, sulfur, selenium-sulfur compound, LiCoO₂ (LCO), LiFePO₄, LiNi_{0.5}Mn_{1.5}O₄, Li₂CoPO₄F, LiNiPO₄, Li₂Ni(PO₄)F, LiMnF₄, LiFeF₄, or LiCo_{0.5}Mn_{1.5}O₄.

6. The battery of claim 5, wherein the cathode further comprises a polymer and/or carbon black.

7. The battery of claim 2, wherein the battery is mechanically constrained.

8. A method of storing energy comprising applying a voltage across the anode and cathode and charging the rechargeable battery of claim 2.

9. A method of providing energy comprising connecting a load to the anode and cathode and discharging the rechargeable battery of claim 2.
